(19) United States
(12) Patent Application Publication
(10) Pub. No.: US 2026/0019574 A1
(43) Pub. Date: Jan. 15, 2026

(54) TECHNIQUES FOR IN-LOOP FILTERING

(71) Applicant: Tencent America LLC, Palo Alto, CA (US)

(72) Inventors: Lien-fei CHEN, Palo Alto, CA (US); Biao WANG, San Jose, CA (US); Stephan WENGER, Hillsborough, CA (US); Yifan WANG, Palo Alto, PA (US); Yonguk YOON, Palo Alto, CA (US); Motong XU, Palo Alto, CA (US); Roman CHERNYAK, Santa Clara, CA (US); Shan LIU, San Jose, CA (US); Ziyue XIANG, Palo Alto, CA (US)

(73) Assignee: Tencent America LLC, Palo Alto, CA (US)

(21) Appl. No.: 19/266,145

(22) Filed: Jul. 10, 2025

Related U.S. Application Data
(60) Provisional application No. 63/671,267, filed on Jul. 14, 2024.
(60) Provisional application No. 63/712,513, filed on Oct. 27, 2024.

(51) Int. Cl. H04N 19/117; H04N 19/124; H04N 19/186; H04N 19/513

(52) U.S. Cl. CPC H04N 19/117; H04N 19/124; H04N 19/186; H04N 19/513

(57) ABSTRACT

Some aspects of the disclosure provide a method of video decoding. For example, a bitstream that comprises coded information of one or more pictures is received. Motion vector information associated with a current chroma sample of a current block in a current picture is derived. The motion vector information points to a reference sample in a reference picture of the current picture. An adaptive loop filter of a temporal domain is applied on the reference sample and one or more neighboring samples of the reference sample in the reference picture to generate a filtering offset for the current chroma sample in the current picture. A filtered value of the current chroma sample is generated according to the filtering offset.

### INCORPORATION BY REFERENCE

The present application claims the benefit of priority to U.S. Provisional Application No. 63/671,267, filed on Jul. 14, 2024, and U.S. Provisional Application No. 63/712,513, filed on Oct. 27, 2024. The entire disclosures of the prior applications are hereby incorporated by reference.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. For example, a bitstream that comprises coded information of one or more pictures is received. Motion vector information associated with a current chroma sample of a current block in a current picture is derived. The motion vector information points to a reference sample in a reference picture of the current picture. An adaptive loop filter of a temporal domain is applied on the reference sample and one or more neighboring samples of the reference sample in the reference picture to generate a filtering offset for the current chroma sample in the current picture. A filtered value of the current chroma sample is generated according to the filtering offset.

Some aspects of the disclosure provide a method for video encoding. In an example, motion vector information associated with a current chroma sample of a current block in a current picture is derived, the motion vector information points to a reference sample in a reference picture of the current picture. An adaptive loop filter of a temporal domain is applied on the reference sample and one or more neighboring samples of the reference sample in the reference picture to generate a filtering offset for the current chroma sample in the current picture. A filtered value of the current chroma sample is generated according to the filtering offset. A plurality of pictures including the current picture are encoded into coded information in a bitstream based on at least the filtered value of the current chroma sample.

Some aspects of the disclosure provide a non-transitory computer readable medium storing a video media bitstream that is encoded by the encoding method.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIGS. 4A-4B show filter shapes of uni-MV filter and bi-MVs filter for luma component (luma samples) in some examples.

FIGS. 5A-5B show filter shapes for chroma component (chroma samples) in some examples.

FIGS. 6A-6B show filter shapes for temporal cross-component adaptive loop filter (CCALF) in some examples.

FIG. 7 shows a diagram of a concatenated motion vector (MV) that includes a motion vector (MV) and a block vector (BV) in an example.

FIG. 8 shows a block diagram of an in-loop filter module in some examples.

FIG. 9 shows a block diagram of an in-loop filter module in some examples.

FIG. 10 shows a block diagram of an in-loop filter module in some examples.

FIG. 11 shows a block diagram of an in-loop filter module in some examples.

FIG. 12 shows a block diagram of an in-loop filter module with chroma input signal enhancement for cascaded in-loop filters in some examples.

FIG. 13 shows a block diagram of an in-loop filter module with chroma input signal enhancement for parallel in-loop filters in some examples.

FIG. 14 shows a flow chart outlining a decoding process according to some aspects of the disclosure.

FIG. 15 shows a flow chart outlining an encoding process according to some aspects of the disclosure.

FIG. 16 shows a flow chart outlining a decoding process according to some aspects of the disclosure.

FIG. 17 shows a flow chart outlining an encoding process according to some aspects of the disclosure.

FIG. 18 is a schematic illustration of a computer system in accordance with an aspect.

### DETAILED DESCRIPTION

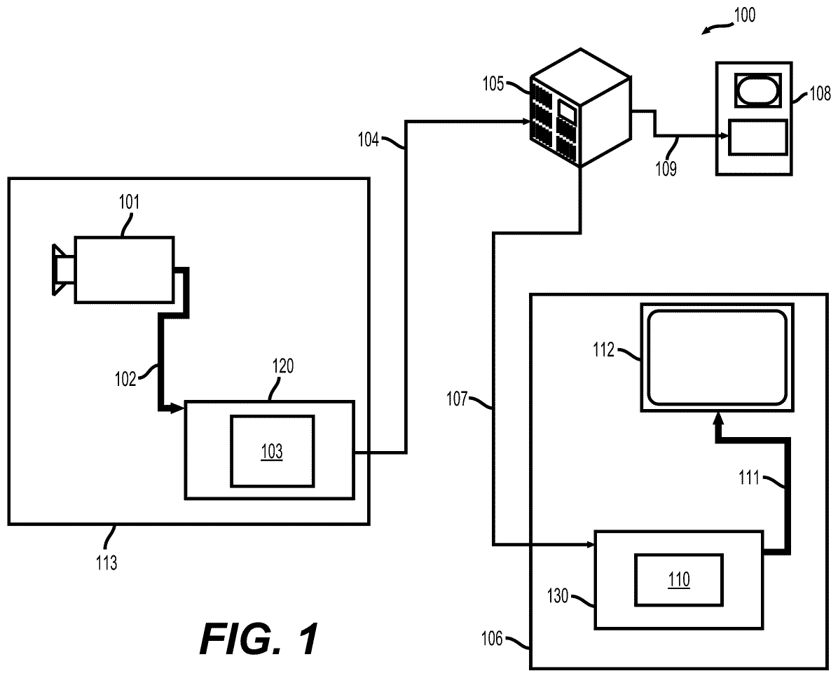

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

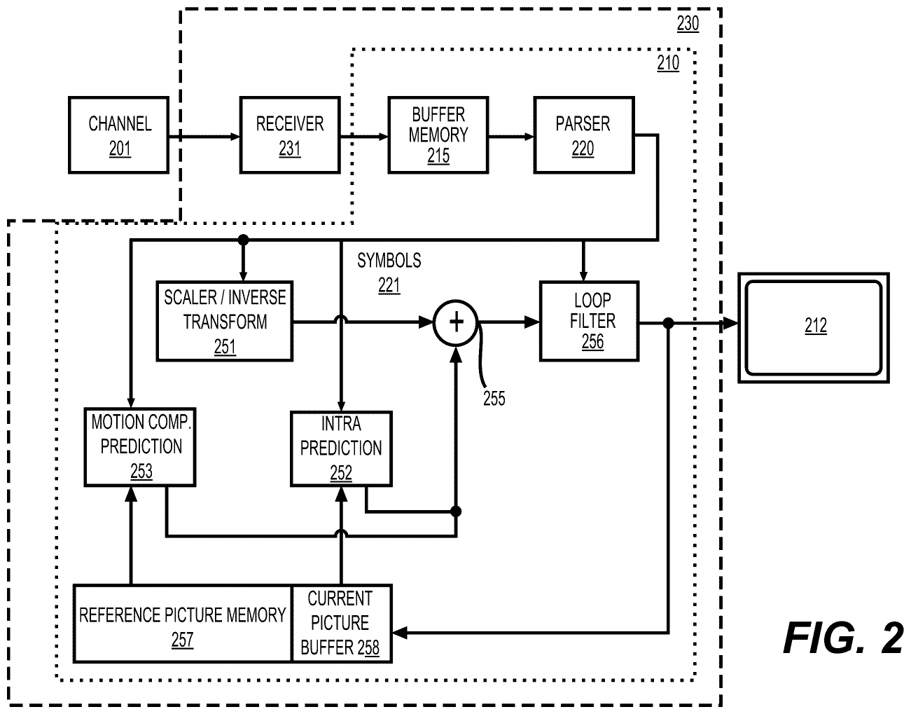

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

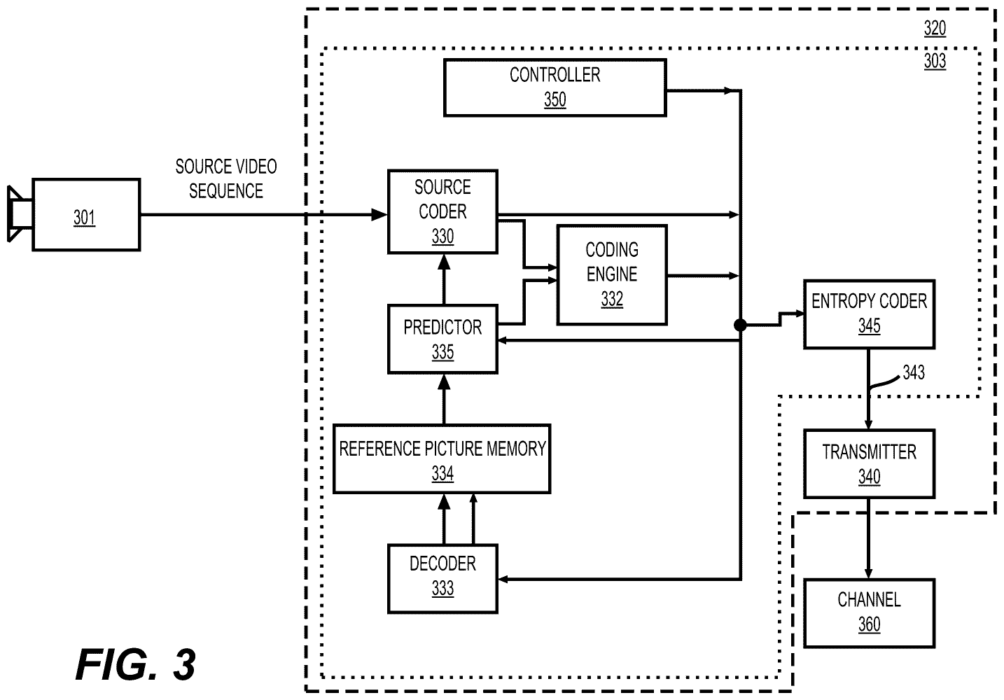

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques of in-loop filtering. In some examples, after a video frame is decoded and reconstructed, adaptive loop filter (ALF) applies a spatial filter to the frame. The ALF can include parameters that are dynamically determined based on the local characteristics of the image content of the frame. The ALF can be applied on blocks or regions of the frame, thus ALF can address different types of artifacts in various areas. The filter coefficients of the ALF are not fixed. In some examples, the filter coefficients are calculated at the encoder side for each frame or region, based on the content and the level of distortion. The filter coefficients can be suitably informed (e.g., signaled in the coded video bitstream) to the decoder.

Some aspects of the disclosure provide techniques of temporal adaptive loop filtering on chroma and cross-component adaptive loop filtering.

In some related video coding technologies, spatial domain adaptive loop filter (ALF) is used as one of in-loop filters. The filter shape of the ALF can be but not limit to be cross shape, diamond shape, and the like. In some examples, the ALF can be applied on luma component or chroma component in the current picture to filter the luma samples and chroma samples respectively. The luma samples can also be used as inputs of a filter (referred to as cross-component loop filter) to filter the chroma samples in the current picture, and the cross-component loop filter can be referred to as cross-component adaptive loop filter (CCALF).

Also in some related video coding technologies, temporal adaptive loop filter (TALF) (also referred to as adaptive loop filter of the temporal domain) can be used to filter the current luma sample by using one or more luma samples in the reference picture that are pointed by a given motion vector of the current luma sample as the inputs of the filtering process. In some examples, the given motion vector is in integer precision for the luma sample fetching from the reference picture. In some examples, two different filter shapes are used for uni-MV filter (e.g., a filter used in uni-prediction that is based on a MV) and bi-MVs filter (e.g., a filter used in bi-prediction that is based on a pair of MVs) respectively.

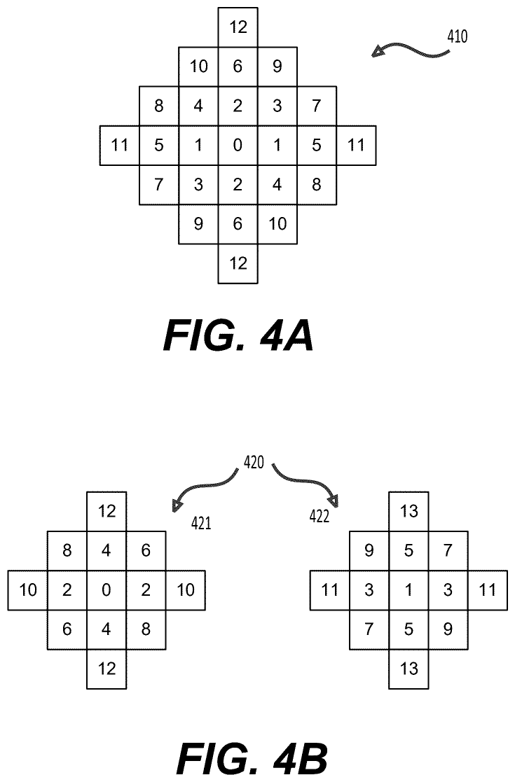

FIGS. 4A-4B show filter shapes of uni-MV filter and bi-MVs filter for luma samples in some examples. FIG. 4A shows a filter shape (410) that can be used in a uni-MV filter in some examples. The filter shape (410) includes 13 filter coefficients (labeled as 0 to 12 in FIG. 4A) that are assigned to locations in the filter shape (410). When a given motion vector is uni-directional motion vector, the filter shape (410) is applied. For example, the center position (labeled as 0) is the reference sample of the current luma sample that the uni-directional motion vector points to, and the filter coefficients can be applied to the reference sample and the neighboring reference samples according to the filter shape (410) to generate an offset.

FIG. 4B shows a filter shape (420) that can be used in bi-MVs filter in some examples. The filter shape (420) includes a first portion (421) and a second portion (422). The filter shape (420) includes 14 filter coefficients (labeled as 0 to 13 in FIG. 4B) that are assigned to locations in the first portion (421) and the second portion (422). When a given motion vector is bi-directional motion vector, the filter shape (420) is applied. For example, the bi-directional motion vector includes a pair of motion vectors that are referred to as a first motion vector and a second motion vector, the first motion vector points to a first location in a first reference picture, and the second motion vector points to a second location in a second reference picture. In an example, the first portion (421) is applied to the first location in the first reference picture (reference samples at the first location and the neighboring locations of the first location in the first reference picture), and the second portion (422) is applied to the second location in the second reference picture (reference samples at the second location and the neighboring locations of the second location in the second reference picture) to generate an offset.

According to some aspects of the disclosure, the techniques of filtering techniques in the present disclosure can be used in any suitable codec designs, and can improve image quality and coding efficiency.

In some aspects, the motion vector information of the current chroma sample is derived and an adaptive loop filter is applied on one or more chroma samples pointed by the derived motion vector in the reference picture to filter the current chroma sample. The adaptive loop filter is referred to as temporal chroma adaptive loop filter, or temporal chroma ALF, in some examples. In some examples, encoder/decoder can derive motion vector information associated with a current chroma sample of a current block in a current picture, the motion vector information points to a reference sample in a reference picture of the current picture. The encoder/decoder can apply an adaptive loop filter of a temporal domain on the reference sample and one or more neighboring samples of the reference sample in the reference picture to generate a filtering offset for the current chroma sample in the current picture, and can generate a filtered value of the current chroma sample according to the filtering offset.

In an aspect, a classifier can be applied on the current sample to determine which signaled filter coefficients are selected. In some examples, multiple sets of filter coefficients for filtering chroma samples are signaled (e.g., using high level syntaxes), and the classifier is used to select a set of filter coefficients from the multiple sets for applying on the current block. In some examples, the classifier is used to determine a classification, and the classification is used to select a filter shape from multiple candidate filter shapes.

In some examples, the filtering equation (for the temporal adaptive loop filtering on Chroma) can be represented based on filtering coefficients, such as using Eq. (1):

$${R}_{cur}^{′} ( i , j ) = {R}_{cur} ( i , j ) + ( ( {\sum }_{k \neq 0} {\sum }_{l \neq 0} f ( k , l ) \times ( {R}_{ref} ( i + k , j + l ) - {R}_{ref} ( i , j ) ) + 64 ) ≫ 7 ) \qquad Eq . ( 1 )$$

where f(k, l) denotes the filter coefficients, R_{cur}(i, j) denotes the current chroma sample,

$$- \frac{L}{2} and \frac{L}{2} ,$$

denotes filtered current chroma sample, and R_{ref}(i, j) denotes a (reference) chroma sample that is pointed by the derived motion vector in the reference picture. The variable k and l vary between

$${R}_{cur}^{′} ( i , j )$$

where L denotes the filter length in some examples.

In some examples, the classification of spatial domain ALF by using the gradient and the activity of the quantized sample value is used to determine the filter coefficients. In an example, gradient(s) of a sample (e.g., a chroma sample) to neighboring samples can be used as input to a classifier to determine a classification, and then the filter coefficients (e.g., a filter shape from multiple candidate filter shapes) can be determined based on the classification. In another example, activity of a sample (e.g., a chroma sample) (e.g., a variation measure to neighboring samples) can be used as input to a classifier to determine a classification, and then the filter coefficients (e.g., a filter shape from multiple candidate filter shapes) can be determined based on the classification.

In some examples, only the quantized sample value of the sample (e.g., chroma sample) is used to determine the filter coefficients. In an example, the quantized sample value of a sample is used as input to a classifier to determine a classification, and then the filter coefficients (e.g., a filter shape from multiple candidate filter shapes) can be determined based on the classification.

In an aspect, a non-linear clipping function can be applied within the filtering process to generate the filtering results. The filtering equation (for the temporal adaptive loop filtering on chroma component) with the non-linear clipping function can be represented using Eq. (2) in an example:

$${R}_{cur}^{′} ( i , j ) = {R}_{cur} ( i , j ) + ( ( {\sum }_{k \neq 0} {\sum }_{l \neq 0} f ( k , l ) \times K ( {R}_{ref} ( i + k , j + l ) - {R}_{ref} ( i , j ) , c ( k , l ) ) + 64 ) ≫ 7 ) \qquad Eq . ( 2 )$$

where f(k, l) denotes the decoded filter coefficients, K(x, y) denotes the clipping function and c(k, l) denotes the decoded clipping parameters, R_{cur}(i, j) denotes the current chroma sample,

$${R}_{cur}^{′} ( i , j )$$

denotes the filtered current chroma sample and R_{ref}(i, j) denotes a reference chroma sample pointed by the derived motion vector in the reference picture. The variable k and l vary between

$$- \frac{L}{2} and \frac{L}{2} ,$$

where L denotes the filter length. In an example, the clipping function

$$K ( x , y ) = min ( y , max ( - y , x ) ) .$$

In an aspect, a flag (e.g., also referred to as activation flag) is signaled by a high level syntax, such as in slice header, picture header and the like to indicate whether the temporal adaptive loop filter for chroma component is used or not at the corresponding level. In some examples, this flag is implicitly derived as false when the slice or the picture is an intra coded picture.

In an aspect, a flag (e.g., also referred to as activation flag) is signaled at a block level, such as signaled at CTU level or coding block level (CU level), to indicate whether the temporal adaptive loop filter for chroma component is used or not at a block. In some examples, the flag is implicitly derived as false when the CTU or coding block is coded as an intra block (e.g., using suitable intra prediction techniques).

In an aspect, the activation flag, either at slice/picture level or CTU/CU block level, is derived implicitly from other available coded information, such as but not limited to block size, temporal layer id, gradient mode, motion vector level, reference picture index (e.g., a distance, such as picture order count difference, between current picture and reference picture).

In an aspect, the motion vector information of the current chroma sample is derived from the motion vector information of the collocated luma sample. The derived motion vector information can be suitably further scaled based on the color format. In some examples, the scaled motion vector can be rounded into the integer precision.

In an aspect, the filter shape and the number of filter taps used in chroma component are identical to the filter shape and the number of filter taps used in the luma component. For example, the filter shapes in FIGS. 4A-4B for luma component can be used as filter shapes for chroma component.

In an aspect, another filter shape is used for chroma component based on the chroma down-sampling format.

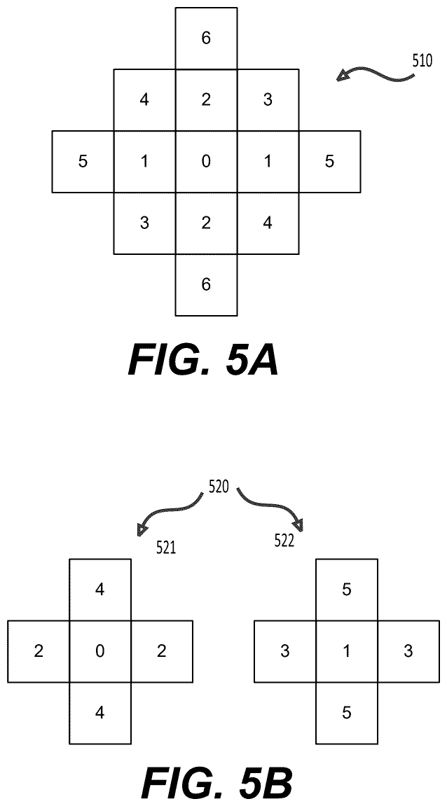

FIGS. 5A-5B show filter shapes for chroma component when the color format is 4:2:0 and the filter shapes in FIGS. 4A-4B are used for luma component in some examples. FIG. 5A shows a filter shape (510) that can be used in a uni-MV filter for chroma component when the filter shape (410) is applied on luma component and the color format is 4:2:0 in some examples. The filter shape (510) includes 7 filter coefficients (labeled as 0 to 6 in FIG. 5A) that are assigned to locations in the filter shape (510). When a given motion vector of a chroma sample is uni-directional motion vector, the filter shape (510) is applied. For example, the center position (labeled as 0) is the reference sample (of the current chroma sample) that the uni-directional motion vector points to, and the filter coefficients can be applied to the reference sample and the neighboring reference samples according to the filter shape (510) to generate an offset.

FIG. 5B shows a filter shape (520) that can be used in a bi-MVs filter for chroma component when the filter shape (420) is applied on luma component and the color format is 4:2:0 in some examples. The filter shape (520) includes a first portion (521) and a second portion (522). The filter shape (520) includes 6 filter coefficients (labeled as 0 to 5 in FIG. 5B) that are assigned to locations in the first portion (521) and the second portion (522). When a given motion vector of a chroma component is bi-directional motion vector, the filter shape (420) is applied on luma component and the color format is 4:2:0, the filter shape (520) is applied on chroma component. For example, the bi-directional motion vector includes a pair of motion vectors that are referred to as a first motion vector and a second motion vector, the first motion vector points to a first location in a first reference picture, and the second motion vector points to a second location in a second reference picture. In an example, the first portion (521) is applied to the chroma component at the first location in the first reference picture (reference samples at the first location and the neighboring locations of the first location in the first reference picture), and the second portion (522) is applied to the chroma component at the second location in the second reference picture (reference samples at the second location and the neighboring locations of the second location in the second reference picture) to generate an offset.

In some aspects of the disclosure, the motion vector information of the current chroma sample is derived and an adaptive loop filter is applied on one or more luma samples pointed by the derived motion vector in the reference picture to filter the current chroma sample. The adaptive loop filter can be referred to as temporal cross-component adaptive loop filter (ALF) or temporal CCALF in some examples. In an example, the filtering equation can be represented by Eq. (3):

$$Δ {I}_{i} ( x , y ) = {\sum }_{( {x}_{0} , {y}_{0} ) ∈ {S}_{i}} {I}_{ref} ( {x}_{Y} + {x}_{0} , {y}_{Y} + {y}_{0} ) {c}_{i} ( {x}_{0} , {y}_{0} ) \qquad Eq . ( 3 )$$

where (x, y) denotes the location of the chroma component i to be refined, (x_{Y}, y_{Y}) denotes the location of the luma component based on (x, y), Sᵢ denotes a filter support area in luma component, I_{ref}(x_{Y}+x₀, y_{Y}+y₀) denotes a luma component of a reference sample in the filter support area, cᵢ(x₀, y₀) denotes the filter coefficients, and ΔIᵢ(x, y) denotes a filter output (e.g., an offset, an adjustment). In some examples, the ΔIᵢ(x, y) is added to the chroma sample value to obtain the final filtered chroma sample. It is noted that, in some examples, when both a temporal chroma ALF and a temporal CCALF are used, the chroma sample value can the filtered output value after the temporal chroma ALF or the original chroma sample value before the temporal chroma ALF.

In an aspect, the filter shape of the temporal cross-component adaptive loop filter is identical to the used filter shape of spatial domain cross-component adaptive loop filtering (e.g., the cross-component adaptive loop filter applied on the samples in the current picture for cross-component filtering).

In an aspect, the motion vector information of the current chroma sample is derived from the motion vector information of the collocated luma sample directly without any scaling. In some examples, the derived motion vector is rounded into the integer precision. In some examples, the motion compensation is applied to generate the one or more luma samples pointed by the derived motion vector when the derived motion vector is not an integer motion vector.

In some examples, a weighted average is calculated based on one or more luma samples on two reference pictures pointed by the bi-directional motion vector (e.g., a pair of motion vectors).

In some examples, two different filter shapes are used for uni-directional MV filtering case and bi-directional MV filtering case respectively.

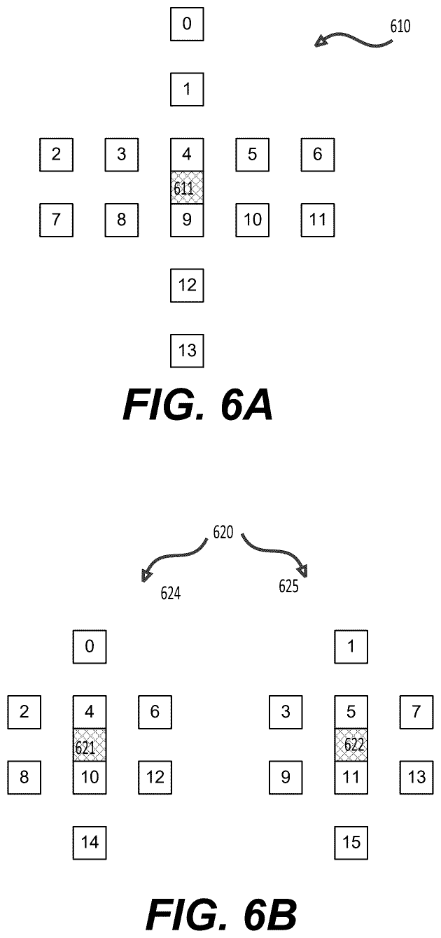

FIGS. 6A-6B show filter shapes for temporal CCALF in some examples. FIG. 6A shows a filter shape (610) that can be used in a uni-MV filter for temporal CCALF in some examples. The filter shape (610) includes 14 filter coefficients (labeled as 0 to 13 in FIG. 6A) that are assigned to locations in the filter shape (610). When a given motion vector of a chroma sample is uni-directional motion vector, the filter shape (610) is applied on luma samples in the reference picture. For example, a location (601) is the location of the chroma sample in the reference picture that is pointed by the uni-directional MV, the location that is labeled by 4 is the collocated luma sample of the chroma sample. The filter coefficients can be applied to the luma samples in the reference picture according to the filter shape (610) to generate an offset.

FIG. 6B shows a filter shape (620) that can be used in a bi-MVs filter for temporal CCALF in some examples. The filter shape (620) includes a first portion (624) and a second portion (625). The filter shape (620) includes 16 filter coefficients (labeled as 0 to 15 in FIG. 6B) that are assigned to locations in the first portion (624) and the second portion (625). When a given motion vector of a chroma sample is bi-directional motion vector, the filter shape (620) is applied on the temporal CCALF. For example, the bi-directional motion vector includes a pair of motion vectors that are referred to as a first motion vector and a second motion vector, the first motion vector points to a first location (621) of a first chroma sample in a first reference picture, and the second motion vector points to a second location (622) of a second chroma sample in a second reference picture. In the FIG. 6B example, the location labeled with 4 is the location of the collocated luma sample of the first chroma sample, and the location labeled with 5 is the location of the collocated luma sample of the second chroma sample.

In an example, the first portion (624) is applied to the luma samples about the first location (621) in the first reference picture, and the second portion (625) is applied to the luma samples about the second location (622) in the second reference picture to generate an offset for the chroma sample in the current picture.

In some examples, the same filter shapes are used for both of uni-directional MV filtering case and bi-directional MV filtering case. For the bi-directional MV filtering case, the total number of filter taps is doubled compared to the filter taps in uni-directional MV case.

In some aspects, the derive MV can be a concatenate MV, by concatenating at least one motion vector and/or at least one block vector. In an example, the derived MV is a concatenated MV by concatenating a first motion vector and a second motion vector. In another example, the derived MV is a concatenated MV by concatenating a motion vector and a block vector.

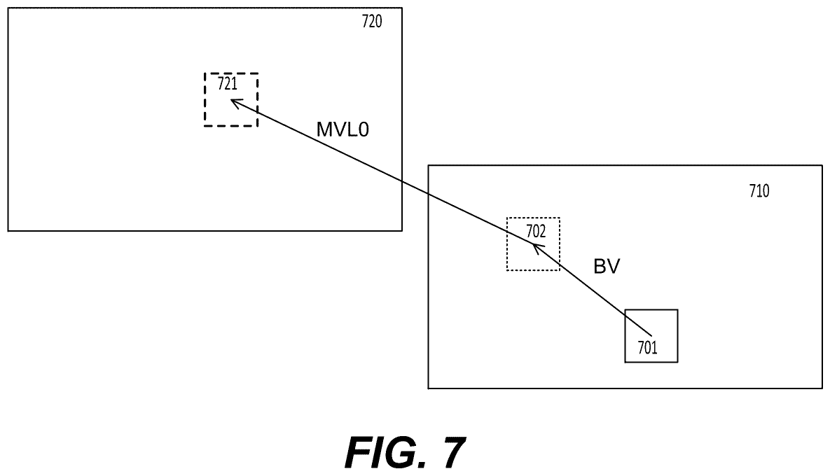

FIG. 7 shows a diagram of a concatenated MV that includes a motion vector (MV) and a block vector (BV) in an example. In the FIG. 7 example, a current block (701) is in a current picture (710). In an example, the current block (701) is coded based on a concatenated MV that includes a block vector (BV) and a motion vector (MVL0). The block vector points to a first reference block (702) in the current picture (710) of the current block (701), and the motion vector (MVL0) points to a second reference block (721) in a reference picture (720) with regard to the first reference block (702). Thus, the concatenated MV points to the second reference block (721) with regard to the current block (701). It is noted that, in some example, the techniques of the temporal chroma ALF and/or the temporal CCALF can be applied when the concatenated MV is the motion vector information of the current block.

Some aspects of the disclosure provide techniques of input signal enhancement for chroma in-loop filter. For example, encoder/decoder can generate reconstructed sample data of a block for filtering by an in-loop filter module, the reconstructed sample data of the block includes luma input data and chroma input data for the in-loop filter module, and the in-loop filter module includes at least a first in-loop filter for applying on luma component of the block to generate luma output data of the block and at least a second in-loop filter for applying on chroma component of the block to generate chroma output data of the block. The encoder/decoder can derive a cross-component filtering model based on correlation between the luma input data and the chroma input data, apply the cross-component filtering model on the luma output data of at least the first in-loop filter to generate cross-component filter data, and generating modified chroma input data based on the cross-component filter data. The encoder/decoder can apply at least the second in-loop filter on the modified chroma input data to generate the chroma output data.

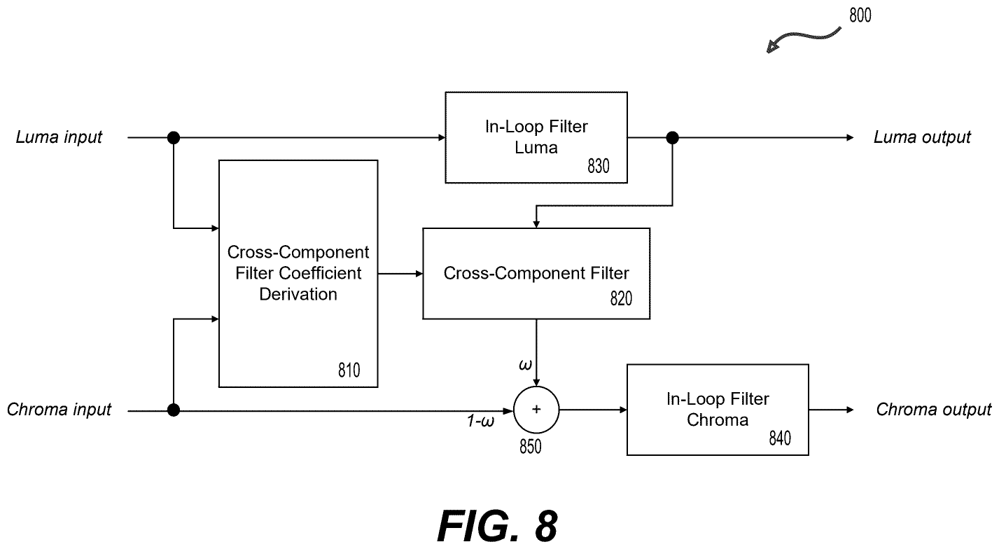

In some aspects, a cross-component filtering model is derived by using the correlation between the luma input data of the in-loop filter module and the chroma input data of the in-loop filter module, and then a cross-component filter is applied, according to the cross-component filtering model, on the luma output data of the in-loop filter module to generate the cross-component filter data as the chroma input of the in-loop filter module for chroma component. In some examples, the techniques can be applied to enhance input signal of a chroma in-loop filter, such as shown in FIG. 8.

FIG. 8 shows a block diagram of an in-loop filter module (800) in some examples. The in-loop filter module (800) receives luma input data and chroma input data for an in-loop filtering, and generates luma output data and chroma output data after the in-loop filtering.

In the FIG. 8 example, the in-loop filter module (800) includes a cross-component filter coefficient derivation unit (810), a cross-component filter (820), a first in-loop filter (830) (e.g., for luma data filtering, also referred to as luma in-loop filter), a second in-loop filter (840) (e.g., for chroma data filtering, also referred to as chroma in-loop filter), and a combining unit (850) that are coupled as shown in FIG. 8. In the FIG. 8 example, the input signal of the chroma in-loop filter (840) is enhanced.

In the FIG. 8 example, the first in-loop filter (830) is applied on the luma input data to generate the luma output data. The cross-component filter coefficient derivation unit (810) can derive a cross-component filtering model by using the correlation between the luma input data of the in-loop filter module (800) and the chroma input data of the in-loop filter module (800). The cross-component filter (820) can be configured according to the derived cross-component filtering model, and can be applied on the luma output data of the in-loop filter module (800) to generate the cross-component filter data. The cross-component filter data and the chroma input data are suitably combined (e.g., weighted sum) by the combining unit (850) to generate combined chroma input (also referred to as modified chroma input data), the second in-loop filter (840) is applied on the combined chroma input to generate the chroma output data.

In an aspect, the in-loop filter module, such as the in-loop filter module (800), can be any suable in-loop filter module, such as a bilateral filter, a shape-adaptive offset filter, and the like.

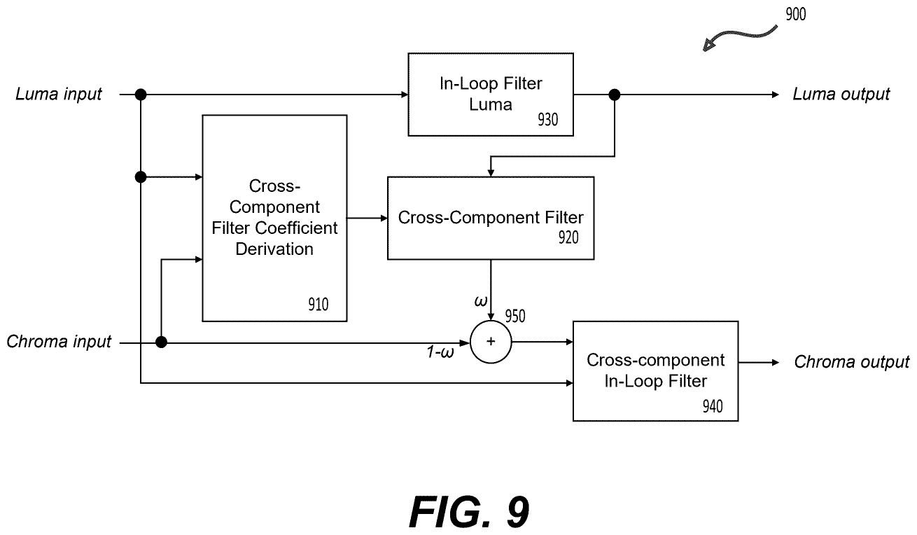

In an aspect, the in-loop filter module, such as the in-loop filter module (800), can be a cross-component in-loop filter for the chroma component, such as a cross-component shape-adaptive offset filter, and the like. In some examples, the techniques can be applied to enhance the input signal of a cross-component in-loop filter, such as shown in FIG. 9.

FIG. 9 shows a block diagram of an in-loop filter module (900) in some examples. The in-loop filter module (900) receives luma input data and chroma input data for an in-loop filtering, and generates luma output data and chroma output data after the in-loop filtering.

In the FIG. 9 example, the in-loop filter module (900) includes a cross-component filter coefficient derivation unit (910), a cross-component filter (920), a first in-loop filter (930) (e.g., for luma data filtering, also referred to as luma in-loop filter), a second in-loop filter (940) (e.g., for cross-component in-loop filtering, also referred to as cross-component in-loop filter), and a combining unit (950) that are coupled as shown in FIG. 9. In the FIG. 9 example, the input signal of the cross-component in-loop filter (940) is enhanced.

In the FIG. 9 example, the first in-loop filter (930) is applied on the luma input data to generate the luma output data. The cross-component filter coefficient derivation unit (910) can derive a cross-component filtering model by using the correlation between the luma input data of the in-loop filter module (900) and the chroma input data of the in-loop filter module (900). The cross-component filter (920) can be configured according to the derived cross-component filtering model, and can be applied on the luma output data of the in-loop filter module (900) to generate the cross-component filter data. The cross-component filter data and the chroma input data are suitably combined (e.g., weighted sum) by the combining unit (950) to generate combined chroma input, the second in-loop filter (940) (also referred to as cross-component in-loop filter) is applied on the combined chroma input and the luma input data to generate the chroma output data.

It is noted that in some codec examples, the in-loop filtering can be performed by a plurality of in-loop filter modules, the techniques of the input signal enhancement for chroma in-loop filtering can be applied on any one or more in the plurality of in-loop filter modules.

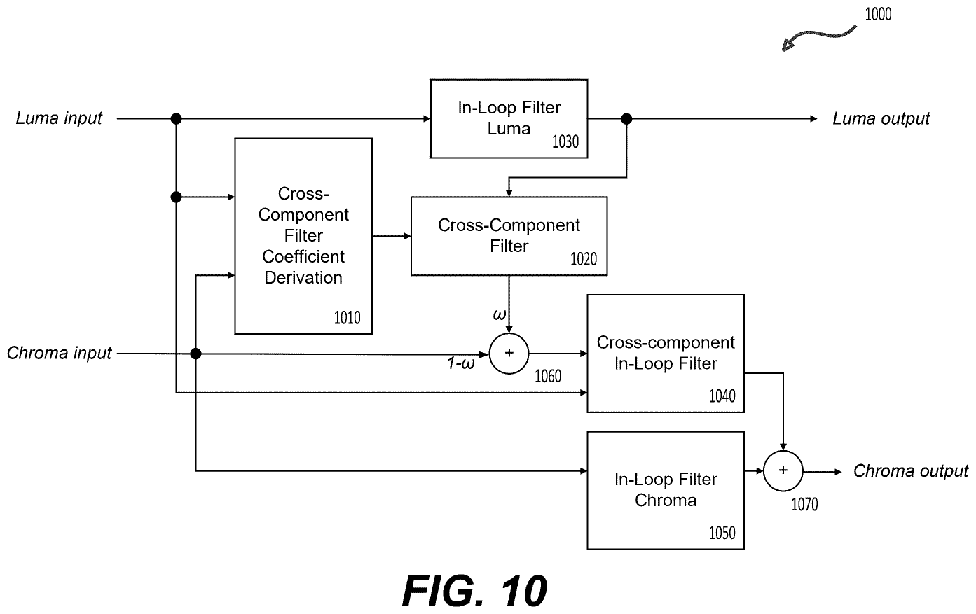

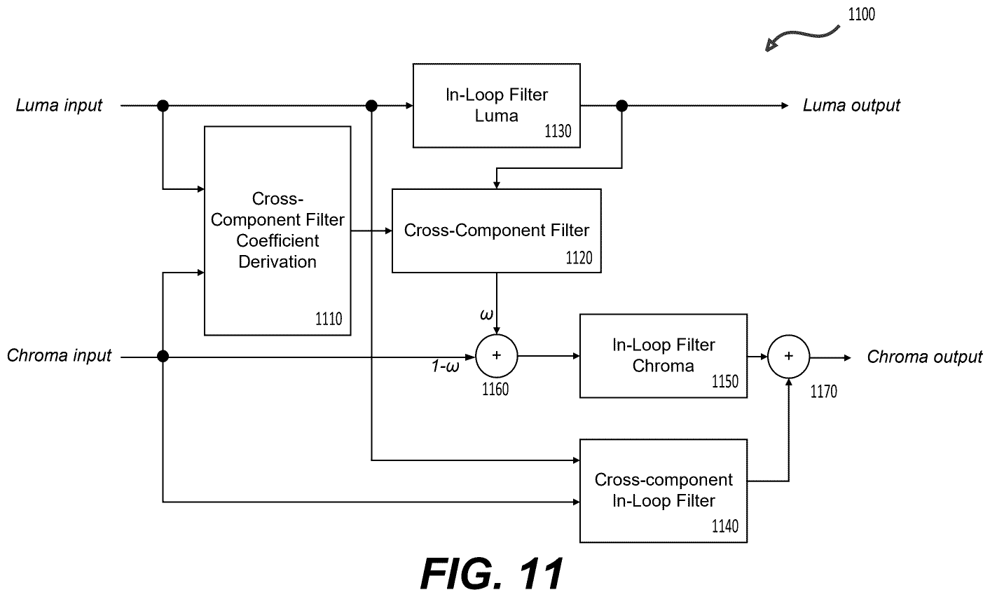

In an aspect, the technique of input signal enhancement can be applied on either a chroma in-loop filter or an associated cross-component in-loop filter when both the chroma in-loop filter and the associated cross-component in-loop filter module for chroma component are available, such as shown in FIG. 10 and FIG. 11.

FIG. 10 shows a block diagram of an in-loop filter module (1000) in some examples. The in-loop filter module (1000) receives luma input data and chroma input data for an in-loop filtering, and generates luma output data and chroma output data after the in-loop filtering.

In the FIG. 10 example, the in-loop filter module (1000) includes a cross-component filter coefficient derivation unit (1010), a cross-component filter (1020), a first in-loop filter (1030) (e.g., for luma data filtering, also referred to as luma in-loop filter), a second in-loop filter (1040) (e.g., for cross-component in-loop filtering, also referred to as cross-component in-loop filter), a third in-loop filter (1050) (e.g., for chroma in-loop filtering, also referred to as chroma in-loop filter), a first combining unit (1060) and a second combining unit (1070) that are coupled as shown in FIG. 10. In the FIG. 10 example, the input signal of the cross-component in-loop filter (1040) is enhanced.

It is noted that the in-loop filter module (1000) can be any in-loop filter module in a plurality of in-loop filter modules in the in-loop filtering process.

In the FIG. 10 example, the first in-loop filter (1030) is applied on the luma input data to generate the luma output data. The cross-component filter coefficient derivation unit (1010) can derive a cross-component filtering model by using the correlation between the luma input data of the in-loop filter module (1000) and the chroma input data of the in-loop filter module (1000). The cross-component filter (1020) can be configured according to the derived cross-component filtering model, and can be applied on the luma output data of the in-loop filter module (1000) to generate the cross-component filter data. The cross-component filter data and the chroma input data are suitably combined (e.g., weighted sum) by the first combining unit (1060) to generate combined chroma input, the second in-loop filter (1040) (also referred to as cross-component in-loop filter) is applied on the combined chroma input and the luma input data to generate a first portion of the chroma output data. The third in-loop filter (1050) (also referred to as chroma in-loop filter) is applied on the chroma input data to generate a second portion of the chroma output data. The first portion of the chroma output data and the second portion of the chroma output data are combined by the second combining unit (1070) to generate the chroma output data.

In the FIG. 10 example, the input signal enhancement is applied on input of cross-component in-loop filter.

FIG. 11 shows a block diagram of an in-loop filter module (1100) in some examples. The in-loop filter module (1100) receives luma input data and chroma input data for an in-loop filtering, and generates luma output data and chroma output data after the in-loop filtering.

In the FIG. 11 example, the in-loop filter module (1100) includes a cross-component filter coefficient derivation unit (1110), a cross-component filter (1120), a first in-loop filter (1130) (e.g., for luma data filtering, also referred to as luma in-loop filter), a second in-loop filter (1140) (e.g., for cross-component in-loop filtering, also referred to as cross-component in-loop filter), a third in-loop filter (1150) (e.g., for chroma in-loop filtering, also referred to as chroma in-loop filter), a first combining unit (1160) and a second combining unit (1170) that are coupled as shown in FIG. 11. In the FIG. 11 example, the input signal of the chroma in-loop filter (1150) is enhanced.

It is noted that the in-loop filter module (1100) can be any in-loop filter module in a plurality of in-loop filter modules in the in-loop filtering process.

In the FIG. 11 example, the first in-loop filter (1130) is applied on the luma input data to generate the luma output data. The cross-component filter coefficient derivation unit (1110) can derive a cross-component filtering model by using the correlation between the luma input data of the in-loop filter module (1100) and the chroma input data of the in-loop filter module (1100). The cross-component filter (1120) can be configured according to the derived cross-component filtering model, and can be applied on the luma output data of the in-loop filter module (1100) to generate the cross-component filter data. The cross-component filter data and the chroma input data are suitably combined (e.g., weighted sum) by the first combining unit (1160) to generate combined chroma input, the third in-loop filter (1150) (also referred to as chroma in-loop filter) is applied on the combined chroma input to generate a first portion of the chroma output data. The second in-loop filter (1140) (also referred to as cross-component in-loop filter) is applied on the luma input data and the chroma input data to generate a second portion of the chroma output data. The first portion of the chroma output data and the second portion of the chroma output data are combined by the second combining unit (1170) to generate the chroma output data.

In the FIG. 11 example, the input signal enhancement is applied on the input of the chroma in-loop filter.

In an aspect, a flag is signaled to indicate whether the input signal enhancement with filtering is applied on chroma input data or not. This flag can be signaled at coding unit level, CTU level, . . . , and the like. In some examples, this flag is signaled only when the in-loop filter module is applied on that coding unit or CTU.

In an aspect, when the cross-component filter data and the chroma input data are combined using weighted sum, the weight value denoted by ω can be a constant value and the weight value range is between [0, 1].

In some aspects, a video codec can include multiple in-loop filter modules.

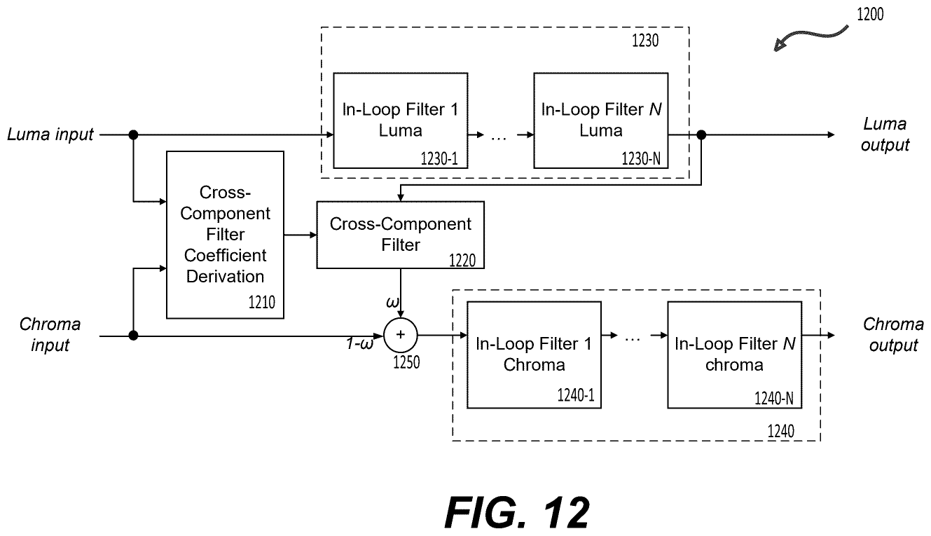

In an aspect, a video codec can include N cascaded in-loop filter modules, N is a positive integer. For example, the luma filter portion can include N cascaded luma in-loop filters, and the chroma filter portion can include N cascaded chroma in-loop filters (including chroma in-loop filters and/or cross-component in-loop filters), N is a positive integer. In some examples, the techniques of input signal enhancement of using the cross-component filter can be applied on the final luma output data of the N cascaded luma in-loop filter to generate the cross-component filter data, and the cross-component filter data can be combined into the chroma input of the 1^{st} chroma in-loop filter in the N cascaded chroma in-loop filters, such as shown in FIG. 12.

FIG. 12 shows a block diagram of an in-loop filter module (1200) with chroma input signal enhancement for cascaded in-loop filters in some examples. The in-loop filter module (1200) receives luma input data and chroma input data for an in-loop filtering, and generates luma output data and chroma output data after the in-loop filtering.

In the FIG. 12 example, the in-loop filter module (1200) includes a cross-component filter coefficient derivation unit (1210), a cross-component filter (1220), a luma in-loop filter portion (1230), a chroma in-loop filter portion (1240), and a combining unit (1250) that are coupled as shown in FIG. 12. The luma in-loop filter portion (1230) includes N luma in-loop filters (1230-1) to (1230-N) that are connected in cascade. The chroma in-loop filter portion (1240) includes N chroma in-loop filters (1240-1) to (1240-N) that are connected in cascade. In the FIG. 12 example, the input signal of the chroma in-loop filter portion (1240) is enhanced.

In the FIG. 12 example, the luma in-loop filter portion (1230) of cascaded luma in-loop filters (1230-1) to (1230-N) can be applied on the luma input data to generate the luma output data. The cross-component filter coefficient derivation unit (1210) can derive a cross-component filtering model by using the correlation between the luma input data of the in-loop filter module (1200) and the chroma input data of the in-loop filter module (1200). The cross-component filter (1220) can be configured according to the derived cross-component filtering model, and can be applied on the luma output data of the in-loop filter module (1200) to generate the cross-component filter data. The cross-component filter data and the chroma input data are suitably combined (e.g., weighted sum) by the combining unit (1250) to generate combined chroma input. The chroma in-loop filter portion (1240) is applied on the combined chroma input to generate the chroma output data.

In some examples, a flag is signaled to indicate whether the chroma input signal enhancement technique is applied or not.

In some examples, when at least one of the N in-loop filters is enabled, a flag is signaled to indicate whether the input signal enhancement with filtering is applied on chroma input data or not. This flag can be signaled at coding unit level, CTU level, . . . , and the like. In some examples, this flag is signaled only when the in-loop filter module is applied on that coding unit or CTU.

In some examples, the chroma in-loop filter portion (1240) includes in-loop filters for chroma components. For example, one or more of the N chroma in-loop filters (1240-1) to (1240-N) can be in-loop filters for chroma components. In some examples, the chroma in-loop filter portion (1240) includes one or more cross-component in-loop filters. For example, one or more of the N chroma in-loop filters (1240-1) to (1240-N) can be cross-component in-loop filters.

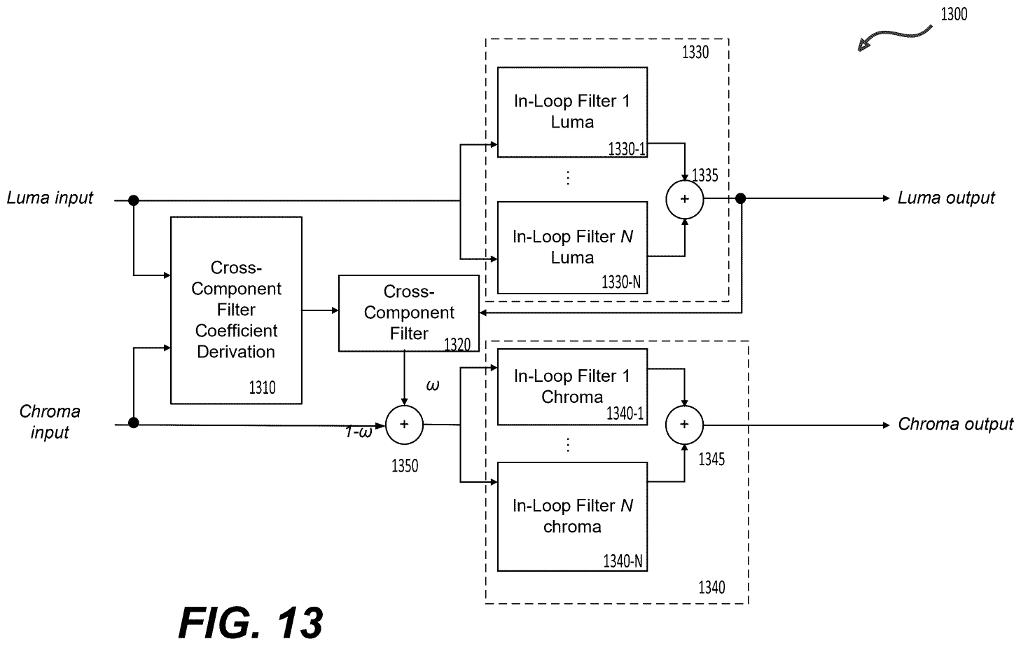

In an aspect, a video codec can include N parallel in-loop filter modules, N is a positive integer. For example, the luma filter portion can include N parallel luma in-loop filters, and the chroma filter portion can include N parallel chroma in-loop filters (including chroma in-loop filters and/or cross-component in-loop filters). In some examples, the techniques of input signal enhancement of using the cross-component filter can be applied on the final luma output data of the N parallel in-loop filters to generate the cross-component filter data as the chroma input of the N parallel chroma in-loop filters, such as shown in FIG. 13.

FIG. 13 shows a block diagram of an in-loop filter module (1300) with chroma input signal enhancement for parallel in-loop filters in some examples. The in-loop filter module (1300) receives luma input data and chroma input data for an in-loop filtering, and generates luma output data and chroma output data after the in-loop filtering.

In the FIG. 13 example, the in-loop filter module (1300) includes a cross-component filter coefficient derivation unit (1410), a cross-component filter (1420), a luma in-loop filter portion (1330), a chroma in-loop filter portion (1340), and a combining unit (1350) that are coupled as shown in FIG. 13. The luma in-loop filter portion (1330) includes N luma in-loop filters (1330-1) to (1330-N) that are connected in parallel, and a combining unit (1335) that combines the outputs of the N luma in-loop filters (1330-1) to (1330-N) into the luma output data. The chroma in-loop filter portion (1340) includes N chroma in-loop filters (1340-1) to (1340-N) that are connected in parallel, and a combining unit (1345) that combines the outputs of the N chroma in-loop filters (1340-1) to (1340-N) into the chroma output data. In the FIG. 13 example, the input signal of the chroma in-loop filter portion (1340) is enhanced.

In the FIG. 13 example, the luma in-loop filter portion (1330) can be applied on the luma input data to generate the luma output data. The cross-component filter coefficient derivation unit (1310) can derive a cross-component filtering model by using the correlation between the luma input data of the in-loop filter module (1300) and the chroma input data of the in-loop filter module (1300). The cross-component filter (1320) can be configured according to the derived cross-component filtering model, and can be applied on the luma output data of the in-loop filter module (1300) to generate the cross-component filter data. The cross-component filter data and the chroma input data are suitably combined (e.g., weighted sum) by the combining unit (1350) to generate combined chroma input. The chroma in-loop filter portion (1340) is applied on the combined chroma input to generate the chroma output data.

In some examples, one flag is signaled to indicate whether the cross-component filter data is applied on all chroma input of the parallel chroma in-loop filters or not.

In some examples, a flag is signaled for each in-loop filter (sub) module to indicate whether the cross-component filter is applied on each in-loop filter (sub) module. For example, the in-loop filter module (1300) includes N in-loop filter sub-modules, an in-loop filter sub-module includes a luma in-loop filter in the luma in-loop filter portion (1330) and a chroma in-loop filter in the chroma in-loop filter portion (1340). In an example, N flags respectively associated with the N in-loop filter sub-modules are signaled. When a flag associated with an in-loop filter sub-module is true, the combined chroma input is the input of the chroma in-loop filter in the in-loop filter sub-module; when a flag associated with an in-loop filter sub-module is false, the chroma input data (without combining with the cross-component filter data) is the input of the chroma in-loop filter in the in-loop filter sub-module.

In some examples, the chroma in-loop filter portion (1340) includes in-loop filters for chroma components. For example, one or more of the N chroma in-loop filters (1340-1) to (1340-N) can be in-loop filters for chroma components. In some examples, the chroma in-loop filter portion (1340) includes one or more cross-component in-loop filters. For example, one or more of the N chroma in-loop filters (1340-1) to (1340-N) can be cross-component in-loop filters.

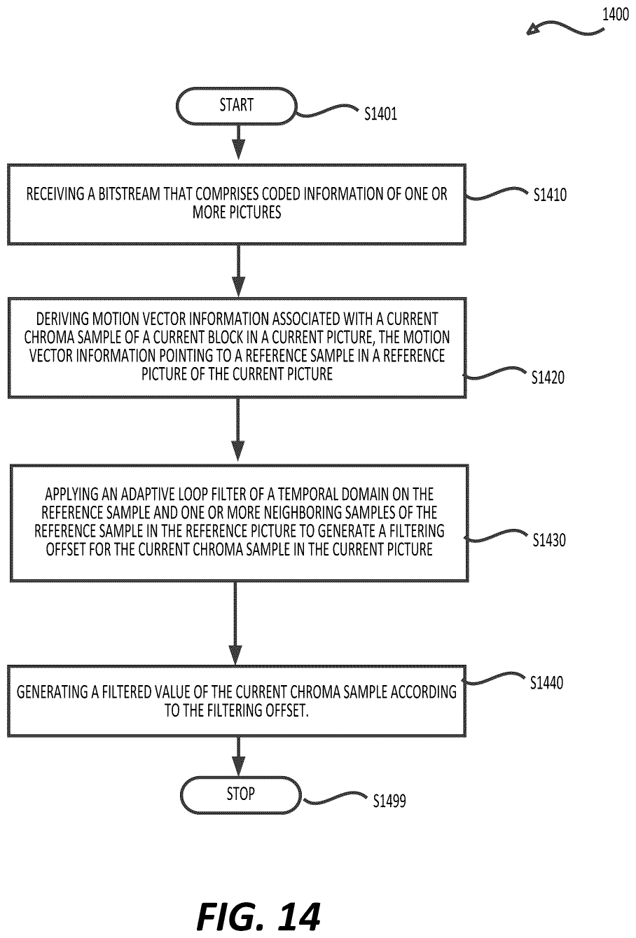

FIG. 14 shows a flow chart outlining a process (1400) according to an aspect of the disclosure. The process (1400) can be used in a video decoder. In various aspects, the process (1400) is executed by processing circuitry, such as the processing circuitry that performs functions of the video decoder (110), the processing circuitry that performs functions of the video decoder (210), and the like. In some aspects, the process (1400) is implemented in software instructions, thus when the processing circuitry executes the software instructions, the processing circuitry performs the process (1400). The process starts at (S1401) and proceeds to (S1410).

At (S1410), a bitstream that comprises coded information of one or more pictures is received.

At (S1420), motion vector information associated with a current chroma sample of a current block in a current picture is derived. The motion vector information points to a reference sample in a reference picture of the current picture.

At (S1430), an adaptive loop filter of a temporal domain is applied on the reference sample and one or more neighboring samples of the reference sample in the reference picture to generate a filtering offset for the current chroma sample in the current picture.

At (S1440), a filtered value of the current chroma sample is generated according to the filtering offset.

In some aspects, a classification from a plurality of classifications is determined based on the current chroma sample, filter coefficients of the adaptive loop filter are selected according to the classification.

In an aspect, quantized sample values of the current chroma sample and one or more neighboring chroma samples of the current chroma sample are calculated. At least one of a gradient of the current chroma sample and/or an activity of the current chroma sample are calculated based on the quantized sample values. The classification is determined according to at least one of the gradient of the current chroma sample and/or the activity of the current chroma sample.

In another aspect, a quantized sample value of the current chroma sample is calculated. The classification is determined according to the quantized sample value.

In some examples, a non-linear clipping function is applied on differences of the one or more neighboring samples to the reference sample to generate clipped differences; and the filtering offset is calculated based on the clipped differences.

In some examples, a flag associated with a region of the current picture including the current chroma sample is decoded from the coded video bitstream, and the flag with a true value indicates to filter chroma samples in the region based on reference samples in the reference picture, the flag with a false value indicates not to filter the chroma samples in the region based on the reference samples in the reference picture. In some examples, the flag of the false value is derived when the region is coded by intra prediction. In an example, the region is the current picture. In another example, the region is a slice that includes the current chroma sample. In another example, the region is a block (e.g., CTU, a coding block and the like) that includes the current chroma sample.

In some examples, the flag is derived based on at least one of: a block size of a block including the current chroma sample; a temporal layer identification; a gradient mode; a motion vector level; a reference picture index; and/or an index difference of the reference picture to the current picture.

In some aspects, the motion vector information of the current chroma sample is derived based on a scaling of motion vector information of a collocated luma sample of the current chroma sample according to a color format. In some examples, first motion vector information of a collocated luma sample of the current chroma sample is scaled according to a color format to obtain second motion vector information, and the second motion vector information is rounded to an integer precision to obtain the motion vector information of the current chroma sample.

In some aspects, the reference sample and the one or more neighboring samples of the reference sample are chroma samples, and the adaptive loop filter of the temporal domain has a same filter shape and a same number of filter coefficients as another adaptive loop filter for applying on luma samples.

In some aspects, the reference sample and the one or more neighboring samples of the reference sample are chroma samples, and the adaptive loop filter of the temporal domain has a different shape and a different number of filter coefficients from another adaptive loop filter for applying on luma samples.

In some aspects, the reference sample and the one or more neighboring samples of the reference sample are luma samples. In some examples, the adaptive loop filter of the temporal domain has a same filter shape as a spatial domain cross-component adaptive loop filter. In some examples, the motion vector information of the current chroma sample is derived based on first motion vector information of a collocated luma sample of the current chroma sample without scaling. In an example, the motion vector information of the current chroma sample is rounded to an integer precision.

In some aspects, the motion vector information includes a non-integer motion vector, and the luma samples in the reference picture are generated according to the motion vector information with an application of motion compensation.

In some aspects, the motion vector information includes a bi-directional motion vector that points to first luma samples in a first reference picture and second luma samples in a second reference picture. The luma samples (to be applied with the adaptive loop filter of the temporal domain) are calculated by weighted average of the first luma samples and the second luma samples.

In some aspects, when the motion vector information includes a uni-directional motion vector, to use the adaptive loop filter of a first filter shape is determined; when the motion vector information includes a bi-directional motion vector, to use the adaptive loop filter of a second filter shape is determined. The first filter shape and the second filter shape are different from each other.

In some aspects, when the motion vector information includes a uni-directional motion vector, the adaptive loop filter includes a first number of filter taps; and when the motion vector information includes a bi-directional motion vector, the adaptive loop filter includes a second number of filter taps, the second number is twice of the first number.

In some aspects, the motion vector information includes a concatenated motion vector that concatenates at least a motion vector and/or at least a block vector.

Then, the process proceeds to (S1499) and terminates.

The process (1400) can be suitably adapted. Step(s) in the process (1400) can be modified and/or omitted. Additional step(s) can be added. Any suitable order of implementation can be used.

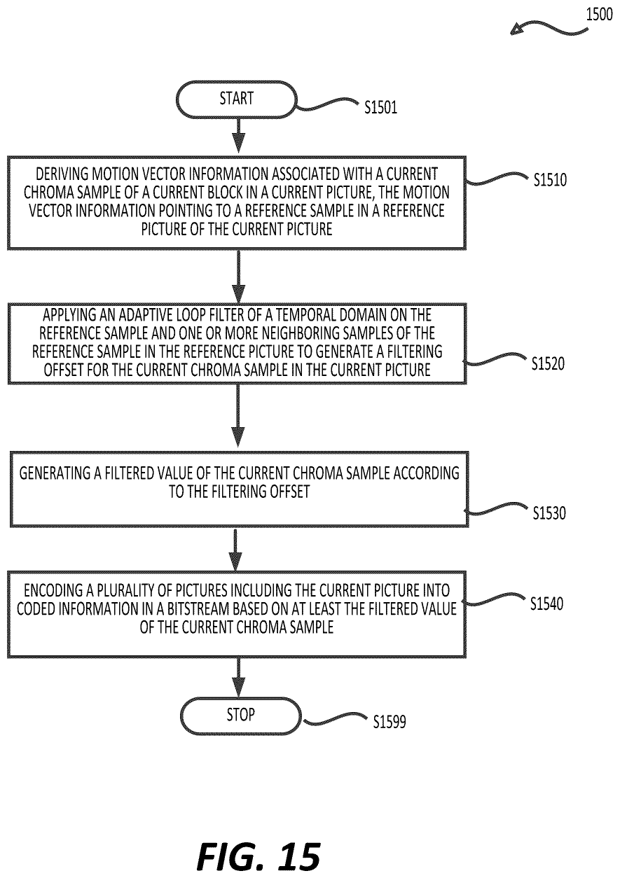

FIG. 15 shows a flow chart outlining a process (1500) according to an aspect of the disclosure. The process (1500) can be used in a video encoder. In various aspects, the process (1500) is executed by processing circuitry, such as the processing circuitry that performs functions of the video encoder (103), the processing circuitry that performs functions of the video encoder (303), and the like. In some aspects, the process (1500) is implemented in software instructions, thus when the processing circuitry executes the software instructions, the processing circuitry performs the process (1500). The process starts at (S1501) and proceeds to (S1510).

At (S1510), motion vector information associated with a current chroma sample of a current block in a current picture is derived, the motion vector information points to a reference sample in a reference picture of the current picture.

At (S1520), an adaptive loop filter of a temporal domain is applied on the reference sample and one or more neighboring samples of the reference sample in the reference picture to generate a filtering offset for the current chroma sample in the current picture.

At (S1530), a filtered value of the current chroma sample is generated according to the filtering offset.

At (S1540), a plurality of pictures including the current picture are encoded into coded information in a bitstream based on at least the filtered value of the current chroma sample.

In some aspects, a classification from a plurality of classifications is determined based on the current chroma sample, and filter coefficients of the adaptive loop filter are selected according to the classification.

In an aspect, quantized sample values of the current chroma sample and one or more neighboring chroma samples of the current chroma sample are calculated. At least one of a gradient of the current chroma sample and/or an activity of the current chroma sample is calculated based on the quantized sample values. The classification is determined according to at least one of the gradient of the current chroma sample and/or the activity of the current chroma sample.

In another aspect, a quantized sample value of the current chroma sample is calculated. The classification is determined according to the quantized sample value.

In some aspects, a non-linear clipping function is applied on differences of the one or more neighboring samples to the reference sample to generate clipped differences, and the filtering offset is calculated based on the clipped differences.

In an aspect, a flag associated with a region of the current picture including the current chroma sample is include in the bitstream, the flag with a true value indicates to filter chroma samples in the region based on reference samples in the reference picture, the flag with a false value indicates not to filter the chroma samples in the region based on the reference samples in the reference picture. The region can be the current picture, a slice that includes the current chroma sample, or a block that includes the current chroma sample.

In some aspects, the motion vector information of the current chroma sample is derived based on a scaling of motion vector information of a collocated luma sample of the current chroma sample according to a color format. In some examples, first motion vector information of a collocated luma sample of the current chroma sample is scaled according to a color format to obtain second motion vector information, and the second motion vector information is rounded to an integer precision to obtain the motion vector information of the current chroma sample.

In some aspects, the reference sample and the one or more neighboring samples of the reference sample are chroma samples, and the adaptive loop filter of the temporal domain has a same filter shape and a same number of filter coefficients as another adaptive loop filter for applying on luma samples.

In some aspects, the reference sample and the one or more neighboring samples of the reference sample are chroma samples, and the adaptive loop filter of the temporal domain has a different shape and a different number of filter coefficients from another adaptive loop filter for applying on luma samples.

In some aspects, the reference sample and the one or more neighboring samples of the reference sample are luma samples. In some examples, the adaptive loop filter of the temporal domain has a same filter shape as a spatial domain cross-component adaptive loop filter. In some examples, the motion vector information of the current chroma sample is derived based on first motion vector information of a collocated luma sample of the current chroma sample without scaling. In an example, the motion vector information of the current chroma sample is rounded to an integer precision.

In some aspects, the motion vector information includes a non-integer motion vector, and the luma samples in the reference picture are generated according to the motion vector information with an application of motion compensation.

In some aspects, the motion vector information includes a bi-directional motion vector that points to first luma samples in a first reference picture and second luma samples in a second reference picture. The luma samples (to be applied with the adaptive loop filter of the temporal domain) are calculated by weighted average of the first luma samples and the second luma samples.

In some aspects, when the motion vector information includes a uni-directional motion vector, to use the adaptive loop filter of a first filter shape is determined; when the motion vector information includes a bi-directional motion vector, to use the adaptive loop filter of a second filter shape is determined. The first filter shape and the second filter shape are different from each other.

In some aspects, when the motion vector information includes a uni-directional motion vector, the adaptive loop filter includes a first number of filter taps; and when the motion vector information includes a bi-directional motion vector, the adaptive loop filter includes a second number of filter taps, the second number is twice of the first number.

In some aspects, the motion vector information includes a concatenated motion vector that concatenates at least a motion vector and/or at least a block vector.

Then, the process proceeds to (S1599) and terminates.

The process (1500) can be suitably adapted. Step(s) in the process (1500) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that motion vector information associated with a current chroma sample of a current block in a current picture is derived. The motion vector information points to a reference sample in a reference picture of the current picture. The format rule also specifies that an adaptive loop filter of a temporal domain is applied on the reference sample and one or more neighboring samples of the reference sample in the reference picture to generate a filtering offset for the current chroma sample in the current picture, and a filtered value of the current chroma sample is generated according to the filtering offset.

According to an aspect of the disclosure, a non-transitory computer readable medium is provided, the non-transitory computer readable storage medium stores a video media bitstream that is encoded by an encoding method, such as the process (1500).

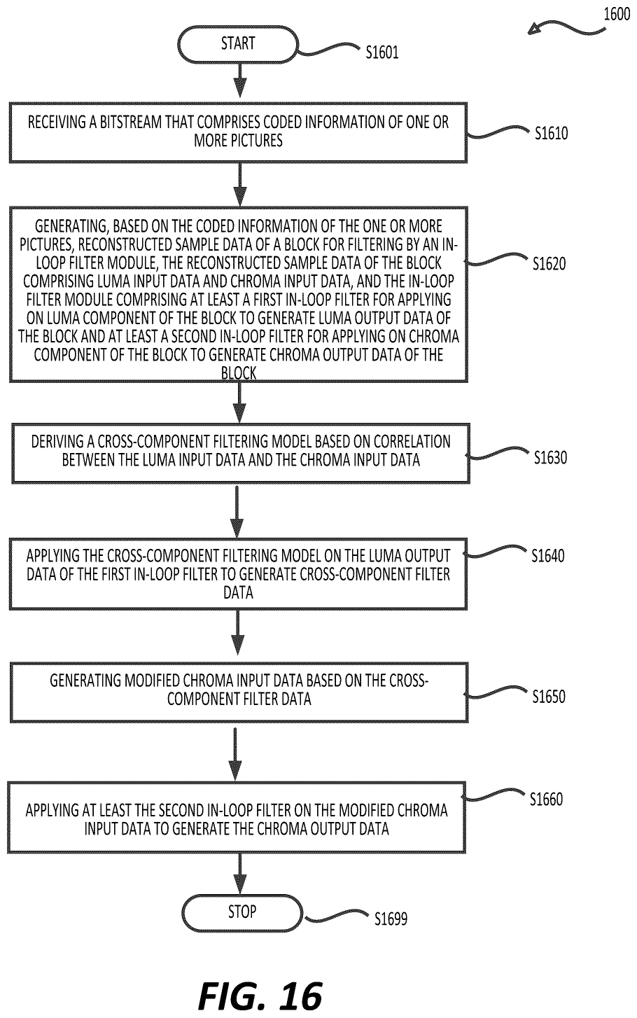

FIG. 16 shows a flow chart outlining a process (1600) according to an aspect of the disclosure. The process (1600) can be used in a video decoder. In various aspects, the process (1600) is executed by processing circuitry, such as the processing circuitry that performs functions of the video decoder (110), the processing circuitry that performs functions of the video decoder (210), and the like. In some aspects, the process (1600) is implemented in software instructions, thus when the processing circuitry executes the software instructions, the processing circuitry performs the process (1600). The process starts at (S1601) and proceeds to (S1610).

At (S1610), a bitstream that includes coded information of one or more pictures is received.

At (S1620), based on the coded information of the one or more pictures, reconstructed sample data of a block for filtering by an in-loop filter module is generated, the reconstructed sample data of the block includes luma input data and chroma input data to the in-loop filter module, and the in-loop filter module includes at least a first in-loop filter for applying on luma component of the block to generate luma output data of the block and at least a second in-loop filter for applying on chroma component of the block to generate chroma output data of the block.

At (S1630), a cross-component filtering model is generated based on correlation between the luma input data and the chroma input data.

At (S1640), the cross-component filtering model is applied on the luma output data of the first in-loop filter to generate cross-component filter data.

At (S1650), modified chroma input data is generated based on the cross-component filter data.

At (S1660), at least the second in-loop filter is applied on the modified chroma input data to generate the chroma output data.

In some aspects, the in-loop filter module includes at least one of a bilateral filter, and a shape-adaptive offset filter.

In some aspects, the second in-loop filter is a chroma in-loop filter that generates the chroma output data based on the modified chroma input data.

In some aspects, the second in-loop filter is a cross-component in-loop filter that generates the chroma output data based on the modified chroma input data and the luma input data.

In some aspects, at least the second in-loop filter includes a chroma in-loop filter that generates a first portion of the chroma output data based on the chroma input data, and a cross-component in-loop filter that generates a second portion of the chroma output data based on the modified chroma input data and the luma input data. A sum of the first portion and the second portion is calculated to generate the chroma output data.

In some aspects, at least the second in-loop filter includes a chroma in-loop filter that generates a first portion of the chroma output data based on the modified chroma input data, and a cross-component in-loop filter that generates a second portion of the chroma output data based on the luma input data. A sum of the first portion and the second portion is calculated to generate the chroma output data.

In some aspects, a flag associated with the block is decoded, the flag indicates whether to modify the chroma input data by applying the cross-component filtering model.

In some aspects, to generate the modified chroma input data, a weighed sum of the chroma input data and the cross-component filter data is calculated, a weight value of the cross-component filter data is a constant value.

In some aspects, the in-loop filter module includes a first plurality of cascaded in-loop filters for applying on the luma component of the block to generate the luma output data of the block and a second plurality of cascaded in-loop filters for applying on the chroma component of the block to generate the chroma output data of the block.

In some aspects, the in-loop filter module includes a first plurality of parallel in-loop filters for applying on the luma component of the block in parallel and a second plurality of parallel in-loop filters for applying on the chroma component of the block in parallel. Luma filtering outputs of the first plurality of parallel in-loop filters are combined to generate the luma output data. The second plurality of parallel in-loop filters are applied on the modified chroma input data in parallel to generate chroma filtering outputs. The chroma filtering outputs are combined into the chroma output data.

Then, the process proceeds to (S1699) and terminates.

The process (1600) can be suitably adapted. Step(s) in the process (1600) can be modified and/or omitted. Additional step(s) can be added. Any suitable order of implementation can be used.

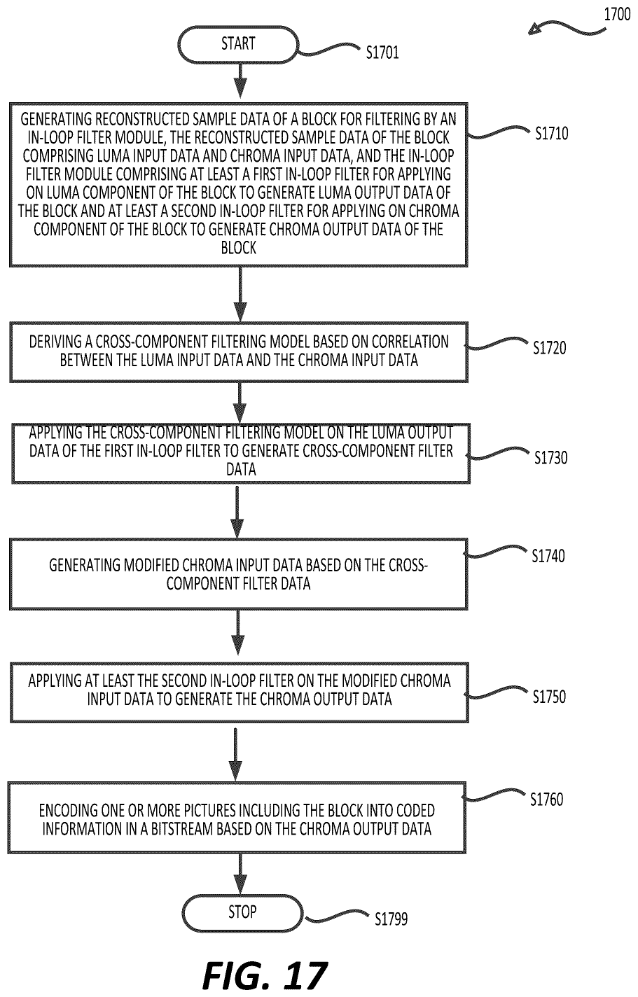

FIG. 17 shows a flow chart outlining a process (1700) according to an aspect of the disclosure. The process (1700) can be used in a video encoder. In various aspects, the process (1700) is executed by processing circuitry, such as the processing circuitry that performs functions of the video encoder (103), the processing circuitry that performs functions of the video encoder (303), and the like. In some aspects, the process (1700) is implemented in software instructions, thus when the processing circuitry executes the software instructions, the processing circuitry performs the process (1700). The process starts at (S1701) and proceeds to (S1710).

At (S1710), reconstructed sample data of a block for filtering by an in-loop filter module is generated. The reconstructed sample data of the block includes luma input data and chroma input data for the in-loop filter module. The in-loop filter module includes at least a first in-loop filter for applying on luma component of the block to generate luma output data of the block and at least a second in-loop filter for applying on chroma component of the block to generate chroma output data of the block.

At (S1720), a cross-component filtering model is derived based on correlation between the luma input data and the chroma input data.

At (S1730), the cross-component filtering model is applied on the luma output data of at least the first in-loop filter to generate cross-component filter data.

At (S1740), modified chroma input data is generated based on the cross-component filter data.

At (S1750), at least the second in-loop filter is applied on the modified chroma input data to generate the chroma output data.

At (S1760), one or more pictures including the block are encoded into coded information in a bitstream based on the chroma output data.

In some aspects, the in-loop filter module includes at least one of a bilateral filter, and a shape-adaptive offset filter.

In some aspects, the second in-loop filter is a chroma in-loop filter that generates the chroma output data based on the modified chroma input data.

In some aspects, the second in-loop filter is a cross-component in-loop filter that generates the chroma output data based on the modified chroma input data and the luma input data.

In some aspects, at least the second in-loop filter includes a chroma in-loop filter that generates a first portion of the chroma output data based on the chroma input data, and a cross-component in-loop filter that generates a second portion of the chroma output data based on the modified chroma input data and the luma input data. A sum of the first portion and the second portion is calculated to generate the chroma output data.

In some aspects, at least the second in-loop filter includes a chroma in-loop filter that generates a first portion of the chroma output data based on the modified chroma input data, and a cross-component in-loop filter that generates a second portion of the chroma output data based on the luma input data. A sum of the first portion and the second portion is calculated to generate the chroma output data.

In some aspects, a flag associated with the block is included in the bitstream, the flag indicates whether to modify the chroma input data by applying the cross-component filtering model.

In some aspects, to generate the modified chroma input data, a weighed sum of the chroma input data and the cross-component filter data is calculated, a weight value of the cross-component filter data is a constant value.

In some aspects, the in-loop filter module includes a first plurality of cascaded in-loop filters for applying on the luma component of the block to generate the luma output data of the block and a second plurality of cascaded in-loop filters for applying on the chroma component of the block to generate the chroma output data of the block.

In some aspects, the in-loop filter module includes a first plurality of parallel in-loop filters for applying on the luma component of the block in parallel and a second plurality of parallel in-loop filters for applying on the chroma component of the block in parallel. Luma filtering outputs of the first plurality of parallel in-loop filters are combined to generate the luma output data. The second plurality of parallel in-loop filters are applied on the modified chroma input data in parallel to generate chroma filtering outputs. The chroma filtering outputs are combined into the chroma output data.

Then, the process proceeds to (S1799) and terminates.

The process (1700) can be suitably adapted. Step(s) in the process (1700) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on the coded information, reconstructed sample data of a block for filtering by an in-loop filter module is generated, the reconstructed sample data of the block includes luma input data and chroma input data to the in-loop filter module, and the in-loop filter module includes at least a first in-loop filter for applying on luma component of the block to generate luma output data of the block and at least a second in-loop filter for applying on chroma component of the block to generate chroma output data of the block. The format rule also specifies that a cross-component filtering model is generated based on correlation between the luma input data and the chroma input data, the cross-component filtering model is applied on the luma output data of the first in-loop filter to generate cross-component filter data, modified chroma input data is generated based on the cross-component filter data, and at least the second in-loop filter is applied on the modified chroma input data to generate the chroma output data.

According to an aspect of the disclosure, a non-transitory computer readable medium is provided, the non-transitory computer readable storage medium stores a video media bitstream that is encoded by an encoding method, such as the process (1700).

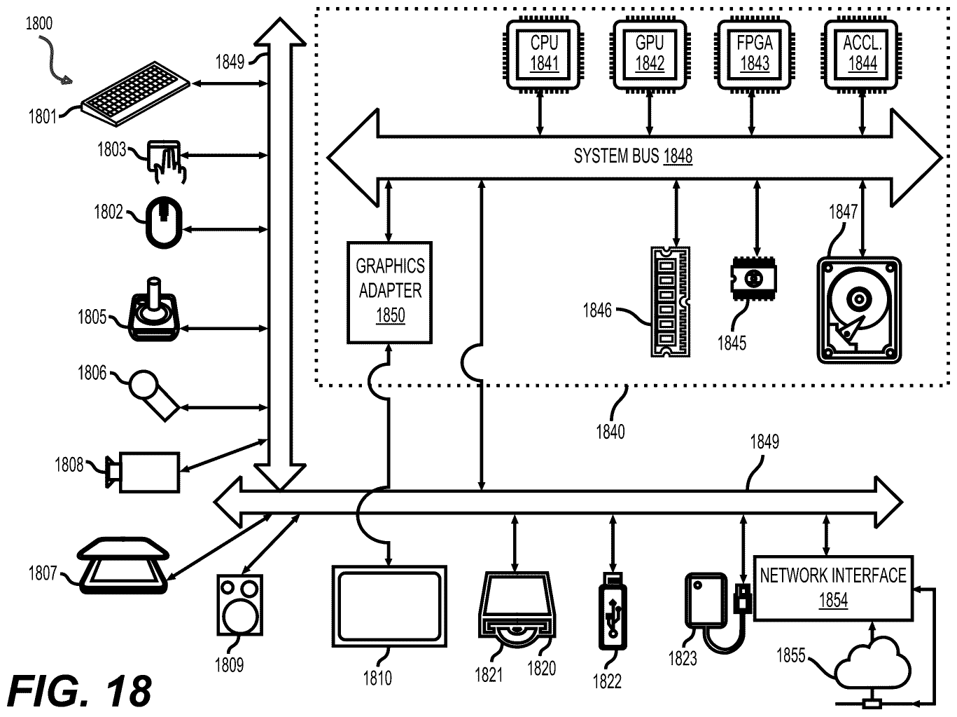

The techniques described above, can be implemented as computer software using computer-readable instructions and physically stored in one or more computer-readable media. For example, FIG. 18 shows a computer system (1800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 18 for computer system (1800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1800).

Computer system (1800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1801), mouse (1802), trackpad (1803), touch screen (1810), data-glove (not shown), joystick (1805), microphone (1806), scanner (1807), camera (1808).

Computer system (1800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1810), data-glove (not shown), or joystick (1805), but there can also be tactile feedback devices that do not serve as input devices), audio output devices (such as: speakers (1809), headphones (not depicted)), visual output devices (such as screens (1810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1800) can also include human accessible storage devices and their associated media such as optical media including CD/DVD ROM/RW (1820) with CD/DVD or the like media (1821), thumb-drive (1822), removable hard drive or solid state drive (1823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1800) can also include an interface (1854) to one or more communication networks (1855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1849) (such as, for example USB ports of the computer system (1800)); others are commonly integrated into the core of the computer system (1800) by attachment to a system bus as described below (for example Ethernet interface into a PC computer system or cellular network interface into a smartphone computer system). Using any of these networks, computer system (1800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1840) of the computer system (1800).

The core (1840) can include one or more Central Processing Units (CPU) (1841), Graphics Processing Units (GPU) (1842), specialized programmable processing units in the form of Field Programmable Gate Areas (FPGA) (1843), hardware accelerators for certain tasks (1844), graphics adapters (1850), and so forth. These devices, along with Read-only memory (ROM) (1845), Random-access memory (1846), internal mass storage such as internal non-user accessible hard drives, SSDs, and the like (1847), may be connected through a system bus (1848). In some computer systems, the system bus (1848) can be accessible in the form of one or more physical plugs to enable extensions by additional CPUs, GPU, and the like. The peripheral devices can be attached either directly to the core's system bus (1848), or through a peripheral bus (1849). In an example, the screen (1810) can be connected to the graphics adapter (1850). Architectures for a peripheral bus include PCI, USB, and the like.

CPUs (1841), GPUs (1842), FPGAs (1843), and accelerators (1844) can execute certain instructions that, in combination, can make up the aforementioned computer code. That computer code can be stored in ROM (1845) or RAM (1846). Transitional data can also be stored in RAM (1846), whereas permanent data can be stored for example, in the internal mass storage (1847). Fast storage and retrieve to any of the memory devices can be enabled through the use of cache memory, that can be closely associated with one or more CPU (1841), GPU (1842), mass storage (1847), ROM (1845), RAM (1846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1800), and specifically the core (1840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1840) that are of non-transitory nature, such as core-internal mass storage (1847) or ROM (1845). The software implementing various aspects of the present disclosure can be stored in such devices and executed by core (1840). A computer-readable medium can include one or more memory devices or chips, according to particular needs. The software can cause the core (1840) and specifically the processors therein (including CPU, GPU, FPGA, and the like) to execute particular processes or particular parts of particular processes described herein, including defining data structures stored in RAM (1846) and modifying such data structures according to the processes defined by the software. In addition or as an alternative, the computer system can provide functionality as a result of logic hardwired or otherwise embodied in a circuit (for example: accelerator (1844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features can be combined in various manners and are not limited to the combinations noted below.

(1). A method of video decoding, including: receiving a bitstream that includes coded information of one or more pictures; deriving motion vector information associated with a current chroma sample of a current block in a current picture, the motion vector information pointing to a reference sample in a reference picture of the current picture; applying an adaptive loop filter of a temporal domain on the reference sample and one or more neighboring samples of the reference sample in the reference picture to generate a filtering offset for the current chroma sample in the current picture; and generating a filtered value of the current chroma sample according to the filtering offset.

(2). The method of feature (1), further including: determining a classification from a plurality of classifications based on the current chroma sample; and selecting filter coefficients of the adaptive loop filter according to the classification.

(3). The method of any of features (1) to (2), in which the determining the classification includes: calculating quantized sample values of the current chroma sample and one or more neighboring chroma samples of the current chroma sample; calculating at least one of a gradient of the current chroma sample and/or an activity of the current chroma sample based on the quantized sample values; and determining the classification according to at least one of the gradient of the current chroma sample and/or the activity of the current chroma sample.

(4). The method of any of features (1) to (3), in which the determining the classification includes: calculating a quantized sample value of the current chroma sample; and determining the classification according to the quantized sample value.

(5). The method of any of features (1) to (4), in which the applying the adaptive loop filter includes: applying a non-linear clipping function on differences of the one or more neighboring samples to the reference sample to generate clipped differences; and calculating the filtering offset based on the clipped differences.

(6). The method of any of features (1) to (5), further including at least one of: decoding a flag associated with a region of the current picture including the current chroma sample, the flag with a true value indicating to filter chroma samples in the region based on reference samples in the reference picture, the flag with a false value indicating not to filter the chroma samples in the region based on the reference samples in the reference picture; and deriving the flag of the false value when the region is coded by intra prediction.

(7). The method of any of features (1) to (6), in which the region includes at least one of: the current picture; a slice that includes the current chroma sample; or a block that includes the current chroma sample.

(8). The method of any of features (1) to (7), further including: deriving the flag based on at least one of: a block size of a block including the current chroma sample; a temporal layer identification; a gradient mode; a motion vector level; a reference picture index; and/or an index difference of the reference picture to the current picture.

(9). The method of any of features (1) to (8), where the deriving includes: deriving the motion vector information of the current chroma sample based on a scaling of motion vector information of a collocated luma sample of the current chroma sample according to a color format.

(10). The method of any of features (1) to (9), where the deriving includes: scaling first motion vector information of a collocated luma sample of the current chroma sample according to a color format to obtain second motion vector information; and rounding the second motion vector information to an integer precision to obtain the motion vector information of the current chroma sample.

(11). The method of any of features (1) to (10), in which the reference sample and the one or more neighboring samples of the reference sample are chroma samples, and the adaptive loop filter of the temporal domain has a same filter shape and a same number of filter coefficients as another adaptive loop filter of the temporal domain for applying on luma samples.

(12). The method of any of features (1) to (11), in which the reference sample and the one or more neighboring samples of the reference sample are chroma samples, and the adaptive loop filter of the temporal domain has a different shape and a different number of filter coefficients from another adaptive loop filter of the temporal domain for applying on luma samples.

(13). The method of any of features (1) to (12), in which the reference sample and the one or more neighboring samples of the reference sample are luma samples.

(14). The method of any of features (1) to (13), in which the adaptive loop filter has a same filter shape as a spatial domain cross-component adaptive loop filter.

(15). The method of any of features (1) to (14), in which the deriving includes: deriving the motion vector information of the current chroma sample based on first motion vector information of a collocated luma sample of the current chroma sample without scaling.

(16). The method of any of features (1) to (15), further including: rounding the motion vector information of the current chroma sample to an integer precision.

(17). The method of any of features (1) to (16), in which the motion vector information includes a non-integer motion vector, and the method includes: generating the luma samples in the reference picture according to the motion vector information with an application of motion compensation.

(18). The method of any of features (1) to (17), in which the motion vector information includes a bi-directional motion vector that points to first luma samples in a first reference picture and second luma samples in a second reference picture, and the method includes: calculating the luma samples by weighted average of the first luma samples and the second luma samples.

(19). The method of any of features (1) to (18), in which the adaptive loop filter has a first filter shape when the motion vector information includes a uni-directional motion vector, and has a second filter shape when the motion vector information includes a bi-directional motion vector, the second filter shape is different from the first filter shape.

(20). The method of any of features (1) to (19), in which the adaptive loop filter has a first number of filter taps when the motion vector information includes a uni-directional motion vector, and has a second number of filter taps when the motion vector information includes a bi-directional motion vector, the second number is twice of the first number.

(21). The method of any of features (1) to (20), in which the motion vector information includes a concatenated motion vector that concatenates at least a motion vector and/or at least a block vector.

(22). A method of video encoding, including: deriving motion vector information associated with a current chroma sample of a current block in a current picture, the motion vector information pointing to a reference sample in a reference picture of the current picture; applying an adaptive loop filter of a temporal domain on the reference sample and one or more neighboring samples of the reference sample in the reference picture to generate a filtering offset for the current chroma sample in the current picture; generating a filtered value of the current chroma sample according to the filtering offset; and encoding a plurality of pictures including the current picture into coded information in a bitstream based on at least the filtered value of the current chroma sample.

(23). The method of feature (22), further including: determining a classification from a plurality of classifications based on the current chroma sample; and selecting filter coefficients of the adaptive loop filter according to the classification.

(24). The method of any of features (22) to (23), in which the determining the classification includes: calculating quantized sample values of the current chroma sample and one or more neighboring chroma samples of the current chroma sample; calculating at least one of a gradient of the current chroma sample and/or an activity of the current chroma sample based on the quantized sample values; and determining the classification according to at least one of the gradient of the current chroma sample and/or the activity of the current chroma sample.

(25). The method of any of features (22) to (24), in which the determining the classification includes: calculating a quantized sample value of the current chroma sample; and determining the classification according to the quantized sample value.

(26). The method of any of features (22) to (25), in which the applying the adaptive loop filter includes: applying a non-linear clipping function on differences of the one or more neighboring samples to the reference sample to generate clipped differences; and calculating the filtering offset based on the clipped differences.

(27). The method of any of features (22) to (26), further including: including, in the bitstream, a flag associated with a region of the current picture including the current chroma sample, the flag with a true value indicating to filter chroma samples in the region based on reference samples in the reference picture, the flag with a false value indicating not to filter the chroma samples in the region based on the reference samples in the reference picture.

(28). The method of any of features (22) to (27), in which the region includes at least one of: the current picture; a slice that includes the current chroma sample; or a block that includes the current chroma sample.

(29). The method of any of features (22) to (28), where the deriving includes: deriving the motion vector information of the current chroma sample based on a scaling of motion vector information of a collocated luma sample of the current chroma sample according to a color format.

(30). The method of any of features (22) to (29), where the deriving includes: scaling first motion vector information of a collocated luma sample of the current chroma sample according to a color format to obtain second motion vector information; and rounding the second motion vector information to an integer precision to obtain the motion vector information of the current chroma sample.

(31). The method of any of features (22) to (30), in which the reference sample and the one or more neighboring samples of the reference sample are chroma samples, and the adaptive loop filter of the temporal domain has a same filter shape and a same number of filter coefficients as another adaptive loop filter of the temporal domain for applying on luma samples.

(32). The method of any of features (22) to (31), in which the reference sample and the one or more neighboring samples of the reference sample are chroma samples, and the adaptive loop filter of the temporal domain has a different shape and a different number of filter coefficients from another adaptive loop filter of the temporal domain for applying on luma samples.

(33). The method of any of features (22) to (32), in which the reference sample and the one or more neighboring samples of the reference sample are luma samples.

(34). The method of any of features (22) to (33), in which the adaptive loop filter of the temporal domain has a same filter shape as a spatial domain cross-component adaptive loop filter.

(35). The method of any of features (22) to (34), in which the deriving includes: deriving the motion vector information of the current chroma sample based on first motion vector information of a collocated luma sample of the current chroma sample without scaling.

(36). The method of any of features (22) to (35), further including: rounding the motion vector information of the current chroma sample to an integer precision.

(37). The method of any of features (22) to (36), in which the motion vector information includes a non-integer motion vector, and the method includes: generating the luma samples in the reference picture according to the motion vector information with an application of motion compensation.

(38). The method of any of features (22) to (37), in which the motion vector information includes a bi-directional motion vector that points to first luma samples in a first reference picture and second luma samples in a second reference picture, and the method includes: calculating the luma samples by weighted average of the first luma samples and the second luma samples.

(39). The method of any of features (22) to (38), in which the adaptive loop filter has a first filter shape when the motion vector information includes a uni-directional motion vector, and has a second filter shape when the motion vector information includes a bi-directional motion vector, the second filter shape is different from the first filter shape.

(40). The method of any of features (22) to (39), in which the adaptive loop filter has a first number of filter taps when the motion vector information includes a uni-directional motion vector, and has a second number of filter taps when the motion vector information includes a bi-directional motion vector, the second number is twice of the first number.

(41). The method of any of features (22) to (40), in which the motion vector information includes a concatenated motion vector that concatenates at least a motion vector and/or at least a block vector.

(42). A non-transitory computer readable medium storing a video media bitstream that is encoded by any of the methods of features (22) to (41).

(43). A method of video decoding, including: receiving a bitstream that includes coded information of one or more pictures; generating, based on the coded information of the one or more pictures, reconstructed sample data of a block for filtering by an in-loop filter module, the reconstructed sample data of the block including luma input data and chroma input data for the in-loop filter module, and the in-loop filter module including at least a first in-loop filter for applying on luma component of the block to generate luma output data of the block and at least a second in-loop filter for applying on chroma component of the block to generate chroma output data of the block; deriving a cross-component filtering model based on correlation between the luma input data and the chroma input data; applying the cross-component filtering model on the luma output data of at least the first in-loop filter to generate cross-component filter data; generating modified chroma input data based on the cross-component filter data; and applying at least the second in-loop filter on the modified chroma input data to generate the chroma output data.

(44). The method of feature (43), in which the in-loop filter module includes at least one of a bilateral filter, and a shape-adaptive offset filter.

(45). The method of any of features (43) to (44), in which the applying at least the second in-loop filter includes: applying a chroma in-loop filter that generates the chroma output data based on the modified chroma input data.

(46). The method of any of features (43) to (45), in which the applying at least the second in-loop filter includes: applying a cross-component in-loop filter that generates the chroma output data based on the modified chroma input data and the luma input data.

(47). The method of any of features (43) to (46), in which the applying at least the second in-loop filter includes: applying a chroma in-loop filter that generates a first portion of the chroma output data based on the chroma input data; applying a cross-component in-loop filter that generates a second portion of the chroma output data based on the modified chroma input data and the luma input data; and calculating a sum of the first portion and the second portion to generate the chroma output data.

(48). The method of any of features (43) to (47), in which the applying at least the second in-loop filter includes: applying a chroma in-loop filter that generates a first portion of the chroma output data based on the modified chroma input data; applying a cross-component in-loop filter that generates a second portion of the chroma output data based on the luma input data; and calculating a sum of the first portion and the second portion to generate the chroma output data.

(49). The method of any of features (43) to (48), further including: decoding a flag associated with the block, the flag indicating whether to modify the chroma input data by applying the cross-component filtering model.

(50). The method of any of features (43) to (49), in which the generating the modified chroma input data further includes: calculating a weighed sum of the chroma input data and the cross-component filter data, a weight value of the cross-component filter data being a constant value.

(51). The method of any of features (43) to (50), in which: the in-loop filter module includes a first plurality of cascaded in-loop filters for applying on the luma component of the block to generate the luma output data of the block and a second plurality of cascaded in-loop filters for applying on the chroma component of the block to generate the chroma output data of the block.

(52). The method of any of features (43) to (51), in which: the in-loop filter module includes a first plurality of parallel in-loop filters for applying on the luma component of the block in parallel and a second plurality of parallel in-loop filters for applying on the chroma component of the block in parallel; the method includes: combining luma filtering outputs of the first plurality of parallel in-loop filters to generate the luma output data; applying the second plurality of parallel in-loop filters on the modified chroma input data in parallel to generate chroma filtering outputs; and combining the chroma filtering outputs into the chroma output data.

(53). A method of video encoding, including: generating reconstructed sample data of a block for filtering by an in-loop filter module, the reconstructed sample data of the block including luma input data and chroma input data for the in-loop filter module, and the in-loop filter module including at least a first in-loop filter for applying on luma component of the block to generate luma output data of the block and at least a second in-loop filter for applying on chroma component of the block to generate chroma output data of the block; deriving a cross-component filtering model based on correlation between the luma input data and the chroma input data; applying the cross-component filtering model on the luma output data of at least the first in-loop filter to generate cross-component filter data; generating modified chroma input data based on the cross-component filter data; applying at least the second in-loop filter on the modified chroma input data to generate the chroma output data; and encoding one or more pictures including the block into coded information in a bitstream based on the chroma output data.

(54). The method of feature (53), in which the in-loop filter module includes at least one of a bilateral filter, and a shape-adaptive offset filter.

(55). The method of any of features (53) to (54), in which the applying at least the second in-loop filter includes: applying a chroma in-loop filter that generates the chroma output data based on the modified chroma input data.

(56). The method of any of features (53) to (55), in which the applying at least the second in-loop filter includes: applying a cross-component in-loop filter that generates the chroma output data based on the modified chroma input data and the luma input data.

(57). The method of any of features (53) to (56), in which the applying at least the second in-loop filter includes: applying a chroma in-loop filter that generates a first portion of the chroma output data based on the chroma input data; applying a cross-component in-loop filter that generates a second portion of the chroma output data based on the modified chroma input data and the luma input data; and calculating a sum of the first portion and the second portion to generate the chroma output data.

(58). The method of any of features (53) to (57), in which the applying at least the second in-loop filter includes: applying a chroma in-loop filter that generates a first portion of the chroma output data based on the modified chroma input data; applying a cross-component in-loop filter that generates a second portion of the chroma output data based on the luma input data; and calculating a sum of the first portion and the second portion to generate the chroma output data.

(59). The method of any of features (53) to (58), further including: including, in the bitstream, a flag associated with the block, the flag indicating whether to modify the chroma input data by applying the cross-component filtering model.

(60). The method of any of features (53) to (59), in which the generating the modified chroma input data further includes: calculating a weighed sum of the chroma input data and the cross-component filter data, a weight value of the cross-component filter data being a constant value.

(61). The method of any of features (53) to (60), in which: the in-loop filter module includes a first plurality of cascaded in-loop filters for applying on the luma component of the block to generate the luma output data of the block and a second plurality of cascaded in-loop filters for applying on the chroma component of the block to generate the chroma output data of the block.

(62). The method of any of features (53) to (61), in which: the in-loop filter module includes a first plurality of parallel in-loop filters for applying on the luma component of the block in parallel and a second plurality of parallel in-loop filters for applying on the chroma component of the block in parallel; the method includes: combining luma filtering outputs of the first plurality of parallel in-loop filters to generate the luma output data; applying the second plurality of parallel in-loop filters on the modified chroma input data in parallel to generate chroma filtering outputs; and combining the chroma filtering outputs into the chroma output data.

(63). A non-transitory computer readable medium storing a video media bitstream that is encoded by any of the methods of features (53) to (62).

(64). An apparatus for video decoding, including processing circuitry that is configured to perform the method of any of features (1) to (21).

(65). An apparatus for video encoding, including processing circuitry that is configured to perform the method of any of features (22) to (41).

(66). An apparatus for video decoding, including processing circuitry that is configured to perform the method of any of features (43) to (52).

(67). An apparatus for video encoding, including processing circuitry that is configured to perform the method of any of features (53) to (62).

(68). A non-transitory computer-readable storage medium storing instructions which when executed by at least one processor cause the at least one processor to perform the method of any of features (1) to (41).

(69). A non-transitory computer-readable storage medium storing instructions which when executed by at least one processor cause the at least one processor to perform the method of any of features (43) to (62).

What is claimed is:

1. A method of video decoding, comprising:
receiving a bitstream that comprises coded information of one or more pictures;
deriving motion vector information associated with a current chroma sample of a current block in a current picture, the motion vector information pointing to a reference sample in a reference picture of the current picture;
applying an adaptive loop filter of a temporal domain on the reference sample and one or more neighboring samples of the reference sample in the reference picture to generate a filtering offset for the current chroma sample in the current picture; and
generating a filtered value of the current chroma sample according to the filtering offset.

2. The method of claim 1, further comprising:
determining a classification from a plurality of classifications based on the current chroma sample; and
selecting filter coefficients of the adaptive loop filter according to the classification.

3. The method of claim 2, wherein the determining the classification comprises:
calculating quantized sample values of the current chroma sample and one or more neighboring chroma samples of the current chroma sample;
calculating at least one of a gradient of the current chroma sample and/or an activity of the current chroma sample based on the quantized sample values; and
determining the classification according to at least one of the gradient of the current chroma sample and/or the activity of the current chroma sample.

4. The method of claim 2, wherein the determining the classification comprises:
calculating a quantized sample value of the current chroma sample; and
determining the classification according to the quantized sample value.

5. The method of claim 1, wherein the applying the adaptive loop filter comprises:
applying a non-linear clipping function on differences of the one or more neighboring samples to the reference sample to generate clipped differences; and
calculating the filtering offset based on the clipped differences.

6. The method of claim 1, further comprising at least one of:
decoding a flag associated with a region of the current picture including the current chroma sample, the flag with a true value indicating to filter chroma samples in the region based on reference samples in the reference picture, the flag with a false value indicating not to filter the chroma samples in the region based on the reference samples in the reference picture; and
deriving the flag of the false value when the region is coded by intra prediction.

7. The method of claim 6, wherein the region comprises at least one of:
the current picture;
a slice that includes the current chroma sample; or
a block that includes the current chroma sample.

8. The method of claim 6, further comprising:
deriving the flag based on at least one of:
a block size of a block including the current chroma sample;
a temporal layer identification;
a gradient mode;
a motion vector level;
a reference picture index; and/or
an index difference of the reference picture to the current picture.

9. The method of claim 1, where the deriving comprises:
deriving the motion vector information of the current chroma sample based on a scaling of motion vector information of a collocated luma sample of the current chroma sample according to a color format.

10. The method of claim 1, where the deriving comprises:
scaling first motion vector information of a collocated luma sample of the current chroma sample according to a color format to obtain second motion vector information; and
rounding the second motion vector information to an integer precision to obtain the motion vector information of the current chroma sample.

11. The method of claim 1, wherein the reference sample and the one or more neighboring samples of the reference sample are chroma samples, and the adaptive loop filter of the temporal domain has a same filter shape and a same number of filter coefficients as another adaptive loop filter of the temporal domain for applying on luma samples.

12. The method of claim 1, wherein the reference sample and the one or more neighboring samples of the reference sample are chroma samples, and the adaptive loop filter of the temporal domain has a different shape and a different number of filter coefficients from another adaptive loop filter of the temporal domain for applying on luma samples.

13. The method of claim 1, wherein the reference sample and the one or more neighboring samples of the reference sample are luma samples.

14. The method of claim 13, wherein the adaptive loop filter has a same filter shape as a spatial domain cross-component adaptive loop filter.

15. The method of claim 13, wherein the deriving comprises:
deriving the motion vector information of the current chroma sample based on first motion vector information of a collocated luma sample of the current chroma sample without scaling.

16. The method of claim 15, further comprising:
rounding the motion vector information of the current chroma sample to an integer precision.

17. The method of claim 15, wherein the motion vector information includes a non-integer motion vector, and the method comprises:
generating the luma samples in the reference picture according to the motion vector information with an application of motion compensation.

18. The method of claim 15, wherein the motion vector information includes a bi-directional motion vector that points to first luma samples in a first reference picture and second luma samples in a second reference picture, and the method comprises:
calculating the luma samples by weighted average of the first luma samples and the second luma samples.

19. A method of video encoding, comprising:
deriving motion vector information associated with a current chroma sample of a current block in a current picture, the motion vector information pointing to a reference sample in a reference picture of the current picture;
applying an adaptive loop filter of a temporal domain on the reference sample and one or more neighboring samples of the reference sample in the reference picture to generate a filtering offset for the current chroma sample in the current picture;
generating a filtered value of the current chroma sample according to the filtering offset; and
encoding a plurality of pictures including the current picture into coded information in a bitstream based on at least the filtered value of the current chroma sample.

20. A non-transitory computer readable medium storing a video media bitstream that is encoded by an encoding method, the encoding method comprising:
deriving motion vector information associated with a current chroma sample of a current block in a current picture, the motion vector information pointing to a reference sample in a reference picture of the current picture;
applying an adaptive loop filter of a temporal domain on the reference sample and one or more neighboring samples of the reference sample in the reference picture to generate a filtering offset for the current chroma sample in the current picture;
generating a filtered value of the current chroma sample according to the filtering offset; and
encoding a plurality of pictures including the current picture into coded information in the video media bitstream based on at least the filtered value of the current chroma sample.
